(19) United States
(12) Patent Application Publication
(10) Pub. No.: US 2002/0146215 A1
(43) Pub. Date: Oct. 10, 2002

(54) Double-sided ferrule manufacturing method, auxiliary member used therein, end surface polishing method for double-sided ferrule, optical connector assembling method, optical connector, guide pin, and optical connector connecting method using the same

(76) Inventors: Takahiro Ogawa, Tokyo (JP); Katsuki Suematsu, Tokyo (JP); Masao Shinoda, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/099,855

(22) Filed: Mar. 14, 2002

(30) Foreign Application Priority Data
Mar. 16, 2001 (JP) 2001-075332
Mar. 16, 2001 (JP) 2001-075335
May 31, 2001 (JP) 2001-165803
Jul. 19, 2001 (JP) 2001-220314
Sep. 20, 2001 (JP) 2001/287500

(51) Int. Cl. G02B 6/36

(52) U.S. Cl. 385/80; 385/83; 385/78

(57) ABSTRACT

Disclosed is a double-sided ferrule manufacturing method, wherein two ferrules are prepared, each ferrule having in one end surface an insertion opening allowing insertion of a fiber ribbon, a plurality of fiber minute holes being arranged ahead of the insertion opening, the fiber minute holes allowing insertion of the individual optical fibers of the fiber ribbon inserted into the insertion opening, the other end surface of each ferrule being formed as a joint end surface in which the end surfaces of the optical fibers inserted into the fiber minute holes are exposed, each of the two ferrules being cut at some midpoint in the fiber ribbon inserting direction along the direction in which the fiber minute holes are arranged to obtain two joint end surface side cut ferrules (members), the cut surfaces of the two members being caused to butt each other to be glued (connected) together, whereby a double-sided ferrule is manufactured which has joint end surfaces on the opposite sides of the glued surfaces (connection surfaces).

### BACKGROUND OF THE INVENTION

1. Field of the Invention

The present invention relates to a method of manufacturing a double-sided ferrule for use in optical communication and to an auxiliary member used therein.

The present invention also relates to an end surface polishing method for a double-sided ferrule for polishing an end surface of a double-sided ferrule into a mirror surface.

The present invention also relates to an optical connector assembling method and to an optical connector.

The present invention also relates to a guide pin for effecting alignment between a pair of optical connectors to be connected and to a method of connecting a pair of optical connectors by using the guide pin.

2. Description of the Related Art

(1) As shown in FIGS. 8A and 8B, a conventional ferrule has in one end surface 1 thereof an insertion hole 4 into which a fiber ribbon 3a (more specifically, individual optical fibers 3 with the external coating thereof removed therefrom) is to be inserted. Ahead of the insertion hole, there are arranged a plurality of guide grooves 5 for respectively guiding the optical fibers 3 inserted through the insertion hole 4, and, ahead of the guide grooves 5, there are arranged a plurality of fiber minute holes 6 into which the optical fibers 3 guided by the guide grooves 5 are inserted. The other end surface 2 is formed as a joint end surface in which the end surfaces of the optical fibers 3 inserted into the fiber minute holes 6 are exposed to the exterior. By butting the joint end surfaces 2 of two ferrules each other, the end surfaces of the optical fibers 3 exposed in the respective joint end surfaces 2 can be optically connected to each other. More specifically, on both outer sides with respect to the lateral direction of the insertion hole 4, there are formed guide pins 7 extending from the end surface 1 to the joint end surface 2. When the joint end surfaces 2 of two ferrules are butted each other, guide pins (not shown) are passed through the guide pin holes 7 communicating with each other, whereby positioning is effected on the two ferrules. That is, the conventional ferrule has only one joint end surface 2, and is generally called a one-side polishing ferrule. In FIG. 8B, the guide grooves 5 and the fiber minute holes 6 are omitted.

(2) As shown in FIG. 14C, in the ferrule of an ordinary MT (mechanically transferable) connector, there is provided at one end an insertion hole 2A through which a fiber ribbon can be inserted. Ahead of it, there is provided, as shown in FIG. 14A, an adhesive injection hole 2B, and, on the inner side thereof, there are provided guide grooves 2C for individually guiding bare optical fibers with the coating removed. Ahead of them, there are provided, as shown in FIG. 14B, optical fiber insertion holes 2D through which the optical fibers can be individually inserted, and, on the outer sides thereof, there are provided guide pin insertion holes 2E (FIGS. 14B and 14C). As shown in FIG. 15A, a double-sided ferrule is having an adhesive injection hole 2B and optical fiber insertion holes 2D (FIGS. 15B and 15C) through which optical fibers can be individually inserted, the optical fiber insertion holes 2D extending through the end surfaces of a ferrule main body 2F.

(3) As shown in FIGS. 20A and 20B, a conventional optical connector ferrule has in one end surface 31 thereof an insertion opening 33 into which a fiber ribbon 32 (more specifically, individual optical fibers 32a with the external coating thereof removed therefrom) is to be inserted. Ahead of the insertion hole, there are arranged a plurality of guide grooves 34 for respectively guiding the optical fibers 32a inserted through the insertion opening 33, and, ahead of the guide grooves 34, there are arranged a plurality of fiber minute holes 35 into which the optical fibers guided by the guide grooves 34 are inserted. The other end surface of the ferrule is formed as a joint end surface 36 in which the end surfaces of the optical fibers 32a inserted into the fiber minute holes 35 are exposed to the exterior. By butting the joint end surfaces 36 of two ferrules 310 each other, the end surfaces of the optical fibers 32a exposed in the respective joint end surfaces 36 can be optically connected to each other. More specifically, on both outer sides with respect to the lateral direction of the insertion opening 33, there are formed guide pins 37 extending from one end surface 31, in which the insertion opening 33 is formed, to the joint end surface 36. When the joint end surfaces 36 of the two ferrules 310 are butted each other as stated above, guide pins (not shown) are passed through the guide pin holes 37 of the ferrules 310 communicating with each other, whereby positioning is effected on the two ferrules 310. Further, in the top surface, there is formed an adhesive injection hole 38 for injecting an adhesive for fixing the fiber ribbon 32 to the ferrule 310. In FIG. 20B, the guide grooves 34 and the fiber minute holes 35 are omitted.

To attach the ferrule 310 to the fiber ribbon 32, the bare optical fibers 32a are inserted into the insertion opening 33, and the optical fibers 32a inserted are placed in the respective guide grooves for alignment. Then, the optical fibers 32a are inserted into the fiber minute holes 35 until the end surfaces of the optical fibers 32a become flush with the joint end surface 36 or slightly protrude outwards from the joint end surface 36. Next, an adhesive is injected from the adhesive injection hole 38 to fix the fiber ribbon 32 to the ferrule 310. The joint end surface 36 of the ferrule 310 thus attached to the fiber ribbon 32 is eventually polished into a mirror surface. Here, when polishing the joint end surface 36, the ferrule 310 attached to the fiber ribbon is set by a stationary jig 311, as shown in FIGS. 21A and 21B, and the joint end surface of 36 is brought into contact with the surface of the polishing disc 311 for polishing,

(4) A plastic optical connector is being developed in order to realize a multi optical fiber structure and achieve an improvement in density, accuracy, mass productivity, a reduction in price, etc. Nowadays, in addition to the use of an optical connector as an end part of telecommunication cable, there is a demand in the market for an optical connector which can be mounted in a module and attached to an electronic substrate. When performing soldering on a module or an electronic substrate on which an optical connector is mounted, heat at solder melting point (approximately 240 to 250° C.) is also applied to the optical connector for at least several tens of seconds or so. Thus, the optical connector is also required to have heat-resistant property.

When assembling a conventional optical connector, there is prepared a ferrule 4C in which, as shown in FIG. 26, guide pin insertion holes 4A and an injection window 4B are formed, optical fibers 4E being inserted into optical fiber insertion holes 4D of the ferrule 4C, as shown in FIG. 27A and 27B. Thereafter, adhesive is injected from the injection window 4B, and is thermally cured to fix the optical fibers 4E to the ferrule 4C. Then, the optical fiber ribbon coating 4F on the outer side of the ferrule 4C is cut and separated. Thereafter, the ferrule end surface 4G is polished to prepare an optical connector.

When mounting and soldering electronic parts, optical connectors, etc. on various types of substrate, such as a printed circuit substrate or a laminated substrate, the substrate is heated in a furnace for soldering. Thereafter, it is extracted from the furnace and exposed to room temperature. Thus, the temperature of the substrate and the optical connector is raised and lowered abruptly. The optical connector expands at high temperature, but does not contract even when restored to room temperature. Further, the ferrule 4C of the optical connector is formed of plastic (e.g., PPS: polyphenylene sulfide, epoxy resin, etc.), whereas the optical fibers 4E are formed of glass, so that only the ferrule 4C expands and the optical fiber 4E does not expand. Further, only the portion of the optical fibers 4E near the injection window 4B is partially fixed by the adhesive injected from the injection window 4B, so that the end surfaces 4H of the optical fibers 4E which have been inserted up to the ferrule end surface 4G as shown in FIG. 28 are retracted into the optical fiber insertion holes 4D of the ferrule 4C.

The connection of the optical fibers 4E inserted into the ferrule and fixed therein is effected by butting the end surfaces 4G of the ferrules each other. In this case, the ferrule end surfaces 4G are polished and the end surfaces 4H of the optical fibers 4E are allowed to protrude from the ferrule end surfaces 4G by 2 μm, and these end surfaces 4H are butted each other to effect PC (physical contact) connection.

(5) When connecting a pair of optical connectors, positioning is effected on the optical connectors by using the guide pin holes of the optical connectors as a reference. For example, as shown in FIG. 36, one ends of guide pins 5A are inserted into guide pin holes 5C of one optical connector 5B from the joint end surface 5D side of the optical connector 5B, and, as shown in FIG. 37, the other ends of the guide pins 5A are caused to protrude outwardly from the joint end surface 5D. Next, an adhesive is injected from adhesive injection holes 5E provided in the top surface of the optical connector 5B to set the guide pins 5A to the optical connector 5B. Thereafter, as shown in FIG. 38, the guide pins 5A outwardly protruding from the joint end surface 5D of the optical connector 5B are inserted into the guide pin holes 5C of the other optical connector 5F, and the joint end surfaces 5D of the optical connectors 5B and 5F are butted each other. Although not shown in FIGS. 36 through 38, optical fibers are previously inserted and fixed in the optical connectors 5B and 5F. It goes without saying that these optical fibers are optically connected when the joint end surfaces 5D of the optical connectors 5B and 5F are butted each other as described above.

There are no particular problems in the above conventional techniques (1) and (3). In the conventional technique (2), the clearance between the optical fiber insertion holes and the outer diameter of the optical fibers is approximately 1 μm, so that it is difficult to insert the optical fibers into the optical fiber insertion holes without using any auxiliary members for insertion. However, even when such auxiliary members are available, the insertion is difficult to perform if its accuracy is not high. For higher accuracy, it might be possible to prepare the auxiliary member by cutting metal. However, that would involve a high level of cutting technique, resulting in a rather high cost per auxiliary member.

The conventional technique (4) has a problem in that, even if PC connection is effected, when the end surfaces 4H of the optical fibers 4E of FIG. 28 are retracted into the optical fiber insertion holes (FIG. 26), a gap is generated between the joint end surfaces of the optical fibers 4C as shown in FIG. 28, resulting in an increase in connection loss. Further, when the adhesive force between the optical fibers and the ferrule, the thermal expansion of the optical connector in the environment of use, etc. are taken into account, there is a limitation regarding the adhesive for the optical connector.

In the conventional technique (5), the following problems are involved when the pair of optical connectors 5B and 5F (FIG. 38) are connected together.

(a) When assembling the optical connectors 5B and 5F, optical fibers (not shown) are inserted and fixed in the ferrules 5G, and then the joint end surfaces 5D of the ferrules 5G (i.e., the joint end surfaces 5D of the optical connectors 5B and 5F) are polished. Thus, when the guide pins 5A are set to one optical connector 5B before polishing the joint end surfaces 5D, the guide pins 5A will be in the way, making it impossible to polish the joint end surface 5D of the optical connector 5B. Thus, the insertion and fixing of the optical fibers into the ferrules 5G and the insertion and fixing of the guide pins 5A in the guide pin holes 5C have to be executed by separate processes, resulting in an increase in the number of processes.

(b) Since the adhesive injection holes 5E for injecting an adhesive into the guide pin holes 5C are very small, it takes time and effort to inject the adhesive. In particular, in a latest optical connector in which an increase in density is to be achieved, it is necessary to make the adhesive injection holes 5E still smaller, so that the above-mentioned problem becomes more serious.

### SUMMARY OF THE INVENTION

(1) A manufacturing method of a double-sided ferrule according to the present invention comprises the steps of: preparing a ferrule forming an insertion opening which allows insertion of a fiber ribbon in one end surface of a ferrule; arranging fiber minute holes ahead of the insertion opening, bare optical fibers obtained by removing an end portion of the fiber ribbon inserted into the insertion opening being capable of being inserted into the fiber minute holes; forming the other end surface of the ferrule as a joint end surface in which the end surfaces of the optical fibers inserted into the fiber minute holes can be exposed; cutting the ferrule at some midpoint in the fiber ribbon inserting direction in the direction in which the fiber minute holes are arranged to thereby form a member equipped with the joint end surface; preparing two members each equipped with such a joint end surface; and causing the cut surfaces of the two members to butt against each other and gluing them together to thereby form a ferrule having two joint end surfaces.

(2) Another manufacturing method of a double-sided ferrule according to the present invention comprises the steps of: using an auxiliary member equipped with a guide pin insertion hole, guide grooves for guiding optical fibers, and optical fiber insertion holes into which the optical fibers can be inserted; inserting a guide pin into the guide pin insertion hole of the auxiliary member and into a guide pin insertion hole of a double-sided ferrule to connect the auxiliary member and the double-sided ferrule with each other; inserting the optical fibers into the optical fiber insertion holes from the guide grooves of the auxiliary member to cause them pass through the insertion holes; and inserting the optical fibers into optical fiber insertion holes of the double-sided ferrule.

(3) A polishing method of an end surface a double-sided ferrule according to the present invention comprises the steps of: preparing two members in each of which one end surface is formed as a joint end surface having two guide pin holes and a plurality of fiber minute holes arranged between the guide pin holes and the other end surface is formed as a gluing end surface, the guide pin holes extending from one end surface to the other end surface; causing the gluing end surface of these two members to butt against each other and gluing them together such that their respective guide pin holes communicate with each other; inserting optical fibers from the fiber minute holes of one member to the fiber minute holes of the other member and fixing the optical fibers to the two members to obtain a double-sided ferrule; and polishing an end surface of the double-side ferrule, with reinforcing members being inserted into the guide pin holes of the two members communicating with each other.

Another polishing method of an end surface of a double-sided ferrule according to the present invention comprises the steps of: preparing two members in each of which one end surface is formed as a joint end surface having two guide pin holes and a plurality of fiber minute holes arranged between the guide pin holes and the other end surface is formed as a gluing end surface, the guide pin holes extending from one end surface to the other end surface; causing the gluing end surface of these two members to butt against each other and gluing them together such that their respective guide pin holes communicate with each other; inserting optical fibers from the fiber minute holes of one member to the fiber minute holes of the other member and fixing the optical fibers to the two members to obtain a double-sided ferrule; and polishing an end surface of the double-side ferrule, with the two members being set by a jig astride the end surfaces of the two members glued to each other.

(4) A first assembling method of an optical connector according to the present invention is a method in which after injecting the adhesive into an inlet of optical fiber insertion holes and into an injection window formed in the ferrule so as to communicate with the optical fiber insertion holes, the bare optical fibers are inserted into the optical fiber insertion holes from the inlet and the adhesive is forced into the optical fiber insertion holes for assembly.

A second assembling method of an optical connector according to the present invention is a method in which after inserting the bare optical fibers into optical fiber insertion holes, the adhesive is injected into an injection window formed in the ferrule so as to communicate with the optical fiber insertion holes, and the adhesive is applied to an inlet side and an outlet side of the optical fiber insertion holes, the bare optical fibers being reciprocated (stroked) in the inserting direction to fill the optical fiber holes with the adhesive.

A third assembling method of an optical connector according to the present invention is a method in which the bare optical fibers are inserted into optical fiber insertion holes, which are filled with the adhesive, and, before the adhesive cures, a coating portion of fiber ribbon on the outer side of the ferrule is cut off to release the bare optical fibers from the restraint by the coating portion before allowing the adhesive to cure.

A fourth assembling method of an optical connector according to the present invention is a method in which after allowing the adhesive to undergo thermosetting, a temperature not lower than glass transition temperature is applied to the adhesive to eliminate the distortion of the adhesive generated at the time of thermosetting, then the adhesive is restored from the glass transition temperature to room temperature over a period of time long enough not to generate distortion in the adhesive.

An optical connector according to the present invention is an optical connector with bare optical fibers inserted into insertion holes being fixed to a ferrule by an adhesive for assembly, in which after injecting the adhesive into an inlet of optical fiber insertion holes and into an injection window formed in the ferrule so as to communicate with the optical fiber insertion holes, the bare optical fibers are inserted into the optical fiber insertion holes from the inlet and the adhesive is forced into the optical fiber insertion holes for assembly.

(5) A guide pin according to the present invention is a guide pin in the form of a bar adapted to be inserted into guide pin holes of a pair of optical connectors connected through butting, in which a longitudinal part of the guide pin is formed as a fixing portion that can be forced into the guide pin hole of one optical connector for fixation, the outer diameter of the fixing portion being larger than that of the remaining portion of the guide pin.

Another guide pin according to the present invention is a guide pin in the form of a bar adapted to be inserted into guide pin holes of a pair of optical connectors connected through butting, in which a longitudinal part of the guide pin is formed as a fixing portion that can be forced into the guide pin hole of one optical connector for fixation, the fixing portion having a large number of engagement protrusions that can be engaged with the inner peripheral surface of the guide pin hole.

A connecting method of an optical connector according to the present invention comprises the steps of: inserting the guide pin according to one of claims 17 through 20 into the guide pin hole of one optical connector from the end surface side on the opposite side of the joint end surface of the optical connector so as to cause a longitudinal part of the guide pin to outwardly protrude from the joint end surface; and inserting the protruding longitudinal part of the guide pin into the guide pin hole of the other optical connector from the joint end surface side of the optical connector to thereby connect the joint end surfaces of the two optical connectors butting against each other.

### BRIEF DESCRIPTION OF THE DRAWINGS

In the accompanying drawings:

FIG. 1 is a diagram showing an example of the double-sided ferrule manufacturing method of the present invention, illustrating a process for obtaining a member equipped with a joint end surface out of an existing ferrule;

FIG. 2A is a diagram illustrating a process for inserting optical fibers into the member equipped with a joint end surface shown in FIG. 1;

FIG. 2B is a diagram illustrating a process for polishing the end portions of the optical fibers protruding from the joint end surface of the member;

FIG. 3A is a diagram illustrating a process for cutting off unnecessary portions of the optical fibers inserted into the member equipped with the joint end surface shown in FIG. 2B;

FIG. 3B is a diagram illustrating a process for inserting guide pins into the member shown in FIG. 3A;

FIG. 3C is a diagram illustrating a process for butting a cut surface of the member shown in FIG. 3B against a cut surface of another member;

FIG. 4A is a diagram illustrating a process for setting the two members shown in FIG. 3C to each other;

FIG. 4B is a diagram illustrating a process for polishing the end portions of the optical fibers protruding from the member shown in FIG. 4A;

FIG. 5A is a diagram showing another example of the double-sided ferrule manufacturing method of the present invention, illustrating a process for butting cut surfaces of two members equipped with joint end surfaces against each other;

FIG. 5B is a diagram illustrating a process for inserting guide pins into the two members shown in FIG. 5A whose cut surfaces are butting against each other;

FIG. 5C is a diagram illustrating a state in which the guide pins have been inserted into the two members shown in FIG. 5B;

FIG. 6A is a diagram illustrating a process for inserting optical fibers into the two members shown in FIG. 5C;

FIG. 6B is a diagram showing a state in which the optical fibers have been inserted into the two members shown in FIG. 6A;

FIG. 6C is a diagram illustrating a process for cutting off unnecessary portions of the optical fibers inserted into the two members shown in FIG. 6B;

FIG. 7 is a diagram illustrating a process for extracting the guide pins from the two members shown in FIG. 6C;

FIGS. 8A and 8B are perspective views showing a conventional ferrule;

FIG. 9A is a left-hand side view showing an example of the auxiliary member of the present invention;

FIG. 9B is an explanatory plan view showing the auxiliary member in a state prior to separation;

FIG. 9C is a right-hand side view showing the auxiliary member of FIG. 9C;

FIGS. 10A through 10D are diagrams illustrating an example of the double-sided ferrule manufacturing method of the present invention;

FIG. 11 is a plan view showing another example of the double-sided ferrule manufacturing method of the present invention;

FIGS. 12A through 12C are diagrams illustrating another example of the double-sided ferrule manufacturing method of the present invention;

FIG. 13 is a diagram illustrating an example of the guide pin used in the double-sided ferrule manufacturing method of the present invention;

FIG. 14A is a plan view showing an example of an MT connector ferrule;

FIG. 14B is a left-hand side view of FIG. 14A;

FIG. 14C is a right-hand side view of FIG. 14A;

FIG. 15A is a plan view showing an example of the double-sided ferrule;

FIG. 15B is a left-hand side view of FIG. 15A;

FIG. 15C is a right-hand side view of FIG. 15A;

FIG. 16A is a diagram illustrating how a ferrule whose end surface is polished by the optical connector ferrule end surface polishing method of the present invention is obtained out of an existing ferrule;

FIG. 16B is a diagram illustrating how cut surfaces of two members obtained are butting against each other;

FIG. 17A is a diagram illustrating a process for inserting optical fibers into fiber minute holes of the two members shown in FIG. 16B;

FIG. 17B is a diagram illustrating an example of a ferrule suitable for end surface polishing by the optical connector ferrule end surface polishing method;

FIG. 18 is a diagram showing an optical connector ferrule end surface polishing method according to an embodiment of the present invention;

FIG. 19 is a diagram showing an optical connector ferrule end surface polishing method according to another embodiment of the present invention;

FIG. 20A is a perspective view of the insertion hole side of an existing ferrule;

FIG. 20B is a perspective view of the joint end surface side thereof;

FIG. 21A is an explanatory front view illustrating an example of a conventional optical connector ferrule end surface polishing method;

FIG. 21B is an explanatory plan view illustrating the polishing method;

FIG. 22A is a plan view showing a first example of the optical connector assembling method of the present invention;

FIG. 22B is a side view illustrating the assembling method;

FIG. 23A is a plan view showing a second example of the optical connector assembling method of the present invention;

FIG. 23B is a side view illustrating the assembling method;

FIG. 24A is a plan view showing a third example of the optical connector assembling method of the present invention;

FIG. 24B is a side view illustrating the assembling method;

FIG. 25A is a diagram illustrating how optical fibers protrude and retract when an optical connector is assembled by a conventional method;

FIG. 25B is a diagram illustrating how optical fibers protrude and retract when an optical connector is assembled by the optical connector assembling method of the present invention;

FIG. 26 is a perspective view showing an example of a ferrule;

FIG. 27A is a plan view illustrating a conventional optical connector assembling method;

FIG. 27B is a side view illustrating the assembling method;

FIG. 28 is a diagram illustrating how optical fiber deviation occurs due to distortion at the time of thermosetting of an optical connector assembled by a conventional optical connector assembling method;

FIG. 29 is a plan view showing an example of a guide pin according to the present invention;

FIG. 30 is a partial enlarged view showing a fixing portion of the guide ping of FIG. 29;

FIG. 31A is a diagram illustrating a state in which guide pins according to the present invention are inserted into guide pin holes of an optical connector;

FIG. 31B is a diagram illustrating a state in which the guide pins are inserted into guide pin holes of a double-sided optical connector;

FIG. 32 is a partial enlarged view showing how engagement protrusions of the fixing portion are engaged in the inner peripheral surface of a guide pin hole;

FIG. 33 is a partial omitted plan view showing another example of the guide pin of the present invention;

FIG. 34A is a diagram illustrating a step in an optical connector connecting method according to the present invention, showing how guide pins are inserted into guide pin holes of a double-sided optical connector;

FIG. 34B is a diagram illustrating a process for inserting guide pins into guide pin holes of a double-sided optical connector;

FIG. 35A is a diagram illustrating a step in an optical connector connecting method according to the present invention, showing how guide pins protruding from the joint end surface of one optical connector are inserted into the guide pin holes of the other optical connector;

FIG. 35B is a diagram showing how a flanged optical connector and a double-sided connector are connected;

FIG. 36 is a diagram illustrating a step in a conventional optical connector connecting method, showing how guide pins are inserted into guide pin holes of an optical connector;

FIG. 37 is a diagram illustrating a step in a conventional optical connector connecting method, showing how the forward end portions of guide pins inserted into the guide pin holes of an optical connector are caused to protrude from the joint end surface of the connector; and

FIG. 38 is a diagram illustrating a step in a conventional optical connector connecting method, showing how guide pins protruding from the joint end surface of one optical connector are inserted into the guide pin holes of the other optical connector.

### DETAILED DESCRIPTION

(Embodiment 1 of Double-Sided Ferrule Manufacturing Method)

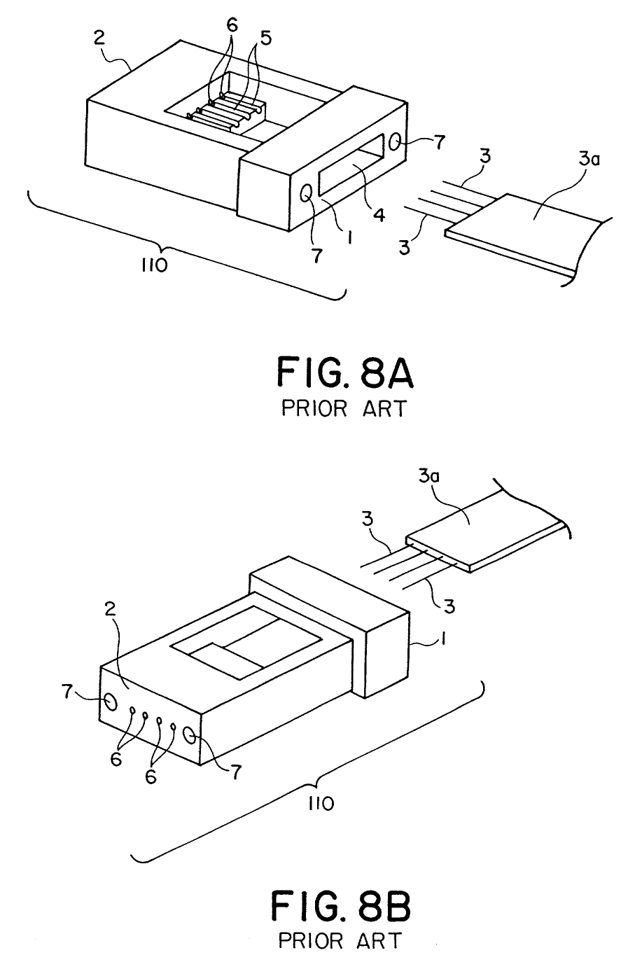

A double-sided ferrule manufacturing method according to an embodiment of the present invention will be described. In the double-sided ferrule manufacturing method of this embodiment, a new ferrule equipped with two joint end surfaces is produced by utilizing the conventional ferrule 110 shown in FIGS. 8A and 8B. The process is as follows:

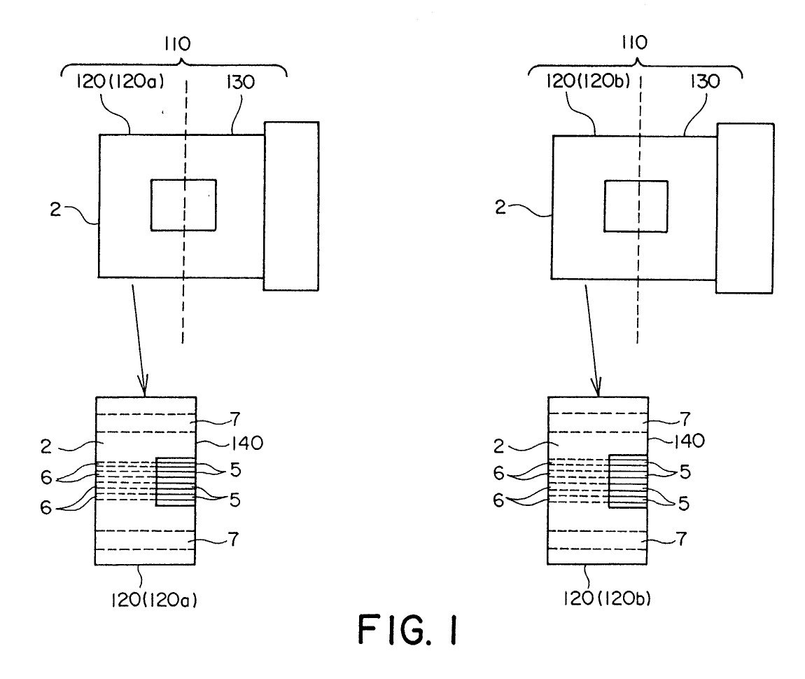

(1) As shown in FIG. 1, two ferrules 110 as shown in FIGS. 8A and 8B are prepared. Each ferrule 110 is cut in the lateral direction (the direction in which the fiber minute holes 6 are arranged in FIG. 8A) along the dotted line of FIG. 1 to divide it into a member 120 equipped with a joint end surface 2 and a member 130 equipped with the insertion hole 4 (FIG. 8A). In this process, it is desirable to set the cut position (indicated by the dotted line of FIG. 1) at some longitudinal midpoint or the start end of the guide grooves 5 shown in FIG. 8A to retain all or a part of the guide grooves 5 in the member 120. The above process is conducted on the two ferrules 110 to obtain two members 120 each equipped with a joint end surface 2.

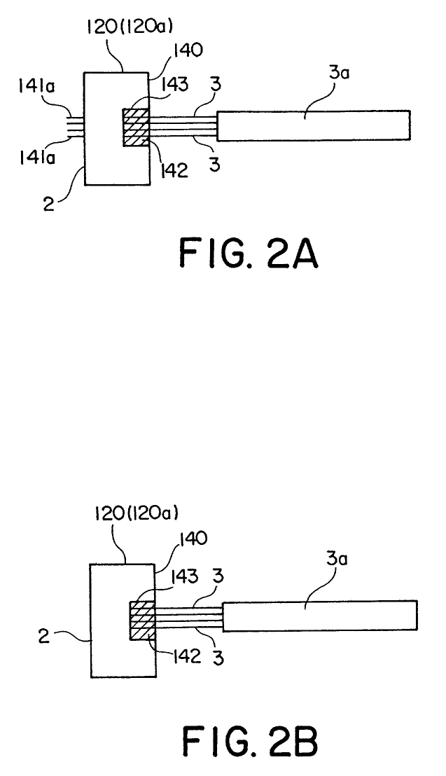

(2) As shown in FIG. 2A, bare optical fibers 3 (more specifically, individual optical fibers 3 with the outer coating of a fiber ribbon 3a removed therefrom) are inserted into the fiber minute holes 6 of one of the two members 120 shown in FIG. 1 (hereinafter referred to as “the member 120a ”) from the cut surface 140 side, and the end portions 141a of the optical fibers 3 are caused to outwardly protrude from the joint end surface 2 of the member 120a. Then, a thermosetting adhesive 143 is injected through the adhesive injection hole 142, and heated in a heating furnace to cure the adhesive 143, thereby securing the optical fibers 3 to the member 120a.

(3) The end portions 141a of the optical fibers 3 protruding from the joint end surface 2 of the member 120a are polished to make the end surfaces of the optical fibers 3 flush with the joint end surface 2, as shown in FIG. 2B.

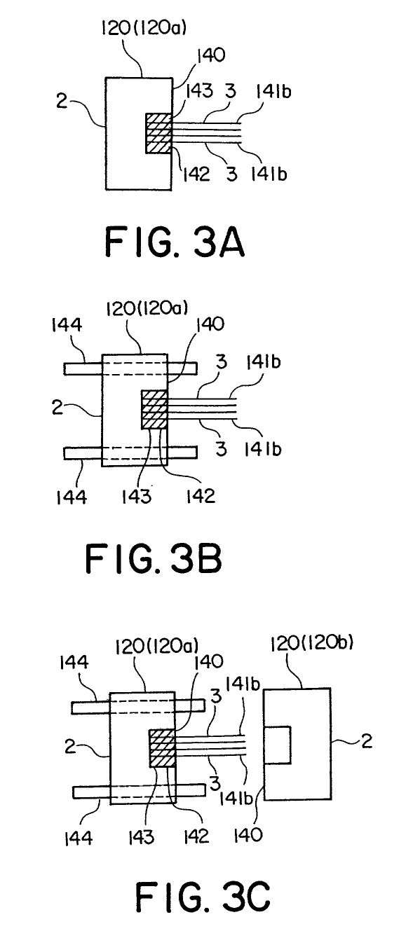

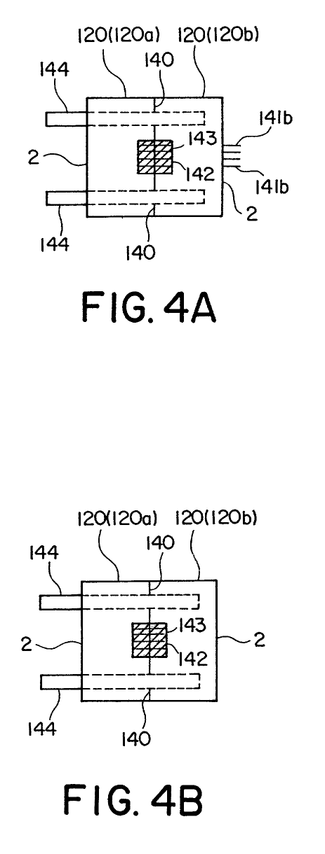

(4) As shown in FIG. 3A, the optical fibers 3 on the cut surface 140 side of the member 120a are cut to a length not less than a predetermined length. The predetermined length is such that when the remaining optical fibers 3 are inserted into the fiber minute holes 6 of the other member 120 (the member 120b) with the joint end surface 2 shown in FIG. 1, the end portions 141b can protrude outwardly from the joint end surface 2 of the other member 120b (FIG. 4A).

(5) As shown in FIG. 3B, guide pins 144 are inserted into the guide pin holes 7 (FIG. 1) of the member 120a, so that one ends thereof protrude outwardly from the joint end surface 2 of the member 120a, the other ends protruding outwardly from the cut surface 140. Here, the protrusion length of the guide pins 144 with respect to the cut surface 140 is such that when they are inserted into the guide pin holes 7 (FIG. 1) of the other member 120b shown in FIG. 1, they do not protrude outwardly from the joint end surface 2 of the other member 120b (FIG. 4A).

(6) Here, as shown in FIG. 3C, the other member 120b is prepared, and a thermosetting adhesive is applied to both or one of the cut surface 140 of the member 120a and 140 of the member 120b. Then, as shown in FIG. 4A, the cut surfaces 140 are butting against each other. Of course, in this process, the guide pins 144 and the optical fibers 3 outwardly protruding from the cut surface 140 of the member 120a shown in FIG. 3C are inserted into the guide pin holes 7 and the fiber minute holes 6 (FIG. 1) of the member 120b shown in FIG. 3C, respectively.

(7) After injecting the thermosetting adhesive 143 into the adhesive injection hole 142 of the member 120b shown in FIG. 4A, heating is effected in a heating furnace to simultaneously cure the adhesive 143 injected into the adhesive injection hole 142 and the adhesive applied to the cut surfaces 140, and fixing is effected between the member 120b and the optical fibers 3 and between the cut surfaces 140 of the members 120a and 120b.

(8) The end portions 141b of the optical fibers 3 outwardly protruding from the joint end surface 2 of the member 120b are polished to make the end surface of the optical fibers 3 flush with the joint end surface 2 of the member 120b as shown in FIG. 4B.

When cutting the ferrule 110 as shown in FIG. 1, it is desirable to use a dicer for cutting a silicon substrate or the like. Further, to finish the cut surface 140 as neat as possible, it is desirable to use a diamond cutter.

The guide pins 144 (FIG. 4B) inserted into the guide pin holes of both members 120a and 120b are fixed to the members 120a and 120b by the adhesive applied to both or one of the cut surfaces 140 to glue the cut surfaces 140 of the members 120a and 120b to each other. More specifically, the adhesive enters the guide pin holes of the members 120a and 120b to fix the guide pins 144 to the members 120a and 120b in the above process (6). After the process (5), positioning is effected on the members 120a and 120b by the guide pins 144 inserted into both the members 120a and 120b. As a result, no positional deviation is caused between the members 120a and 120b, nor is any external force due to positional deviation of the members 120a and 120b applied to the optical fibers 3.

(Embodiment 2 of Double-Sided Ferrule Manufacturing Method)

A double-sided ferrule manufacturing method according to another embodiment of the present invention will be described. As far as the process for obtaining the member 120 equipped with the joint end surface 2 is concerned, the double-sided ferrule manufacturing method of this embodiment is the same as that of embodiment 1. Thus, the process other than the above will be described.

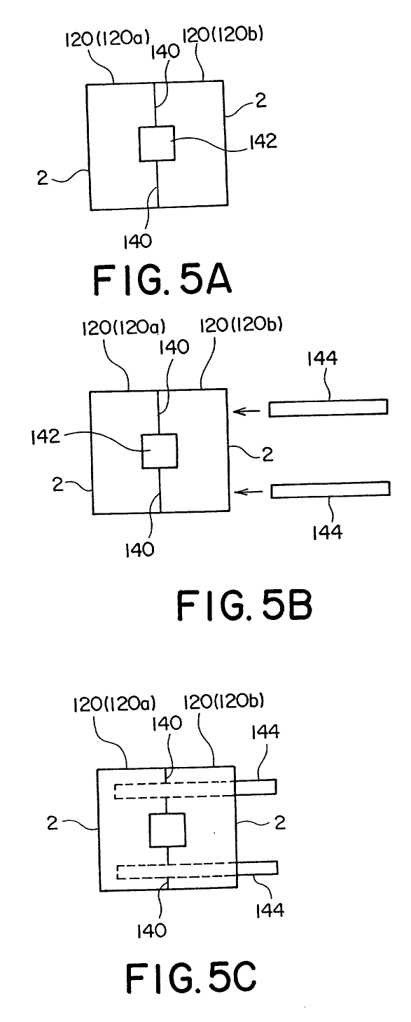

(1) As shown in FIG. 5A, an adhesive is applied to both or one of the cut surfaces 140 of the members 120a and 120b shown in FIG. 1, and then the cut surfaces 140 are butting against each other.

(2) As shown in FIG. 5B, one ends of the guide pins 144 are inserted into the guide pin holes 7 (FIG. 1) of the member 120b. Further, as shown in FIG. 5C, the guide pins 144 are inserted into the guide pin holes 7 (FIG. 1) of the member 120a communicating with the above guide pin holes 7. That is, the guide pins 144 are inserted into the guide pin holes 7 of both the members 120a and 120b communicating with each other. Here, the insertion length is adjusted such that the other ends of the guide pins 144 are not inserted into the guide pin holes 7 of the other member 120b. Further, oil (grease) is previously applied to the outer peripheral surfaces of the guide pins 144.

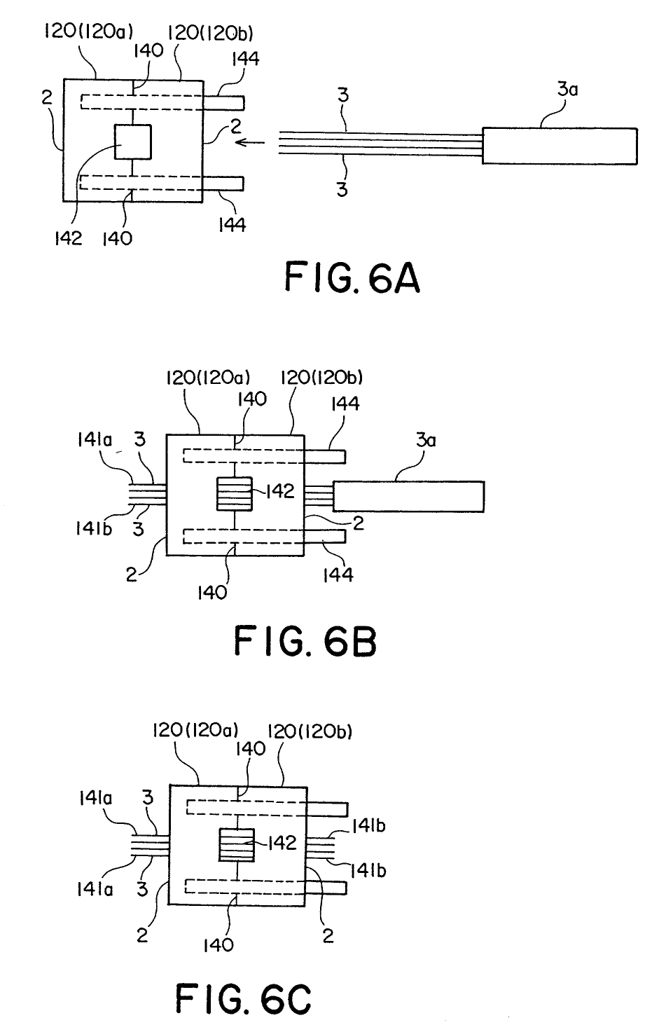

(3) As shown in FIG. 6A, the bare optical fibers 3 (more specifically, the individual optical fibers 3 with the outer coating of the fiber ribbon 3a removed therefrom) are inserted into the fiber minute holes 6 (FIG. 1) of the other member 120b from the joint end surface 2 side. Further, as shown in FIG. 6B, the optical fibers 3 are inserted into the fiber minute holes 6 (FIG. 1) of the member 120a communicating with the above fiber minute holes 6 through the guide grooves 5 (FIG. 1). Further, the end portions 141a of the optical fibers 3 are caused to protrude outwardly from the joint end surface 2 of the member 120a. That is, the optical fibers 3 are inserted into the fiber minute holes 6 of both the members 120a and 120b communicating with each other.

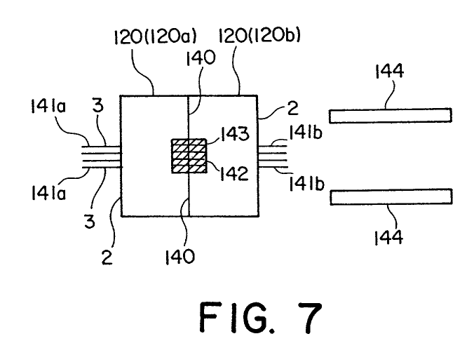

(4) As shown in FIG. 6C, the optical fibers 3 protruding outwardly from the joint end surface 2 of the other member 120b are cut off to a length not less than a predetermined length, and the thermosetting adhesive 143 (FIG. 7) is injected into the adhesive injection hole 142. Thereafter, heat is applied to the adhesive 143 in a heating furnace to cure the adhesive 143. That is, fixing is effected simultaneously between the optical fibers and the members 120a and 120b and between the cut surfaces 140 of the members 120a and 120b. Naturally, this shortens the operation time.

(5) The ferrule is taken out of the heating furnace, and, as shown in FIG. 7, the guide pins 144 are pulled out of the members 120a and 120b. Here, while the adhesive has already been cured by heating, the adhesive applied to the cut surfaces 140 of the members 120a and 120b is prevented from entering the guide pin holes 7 (FIG. 1) by the oil previously applied to the outer peripheral surfaces of the guide pins 144; even if the adhesive enters the guide pin holes 7, it is prevented from coming into contact with the outer peripheral surfaces of the guide pins 144. Thus, the guide pins 144 can be easily pulled out of the members 120a and 120b.

(6) Thereafter, the end portions 141a and 141b of the optical fibers 3 outwardly protruding from the joint end surfaces 2 of the members 120a and 120b are polished to make the end surfaces of the optical fibers 3 flush with the joint end surface 2 of the member 120a or 120b. In this case, the guide pins 144 have already been pulled out. That is, as shown in FIG. 4B, the guide pins 144 do not protrude from the joint end surface 2 of the member 120a or 120b, so that the guide pins 144 are not in the way, making it possible to collectively polish the end portions 141a and 141b of the optical fibers 3 protruding from the respective joint end surfaces 2 of the members 120a and 120b.

Also in the double-sided ferrule manufacturing method of this embodiment, alignment is effected on the members 120a and 120b by the guide pins 144 inserted into both the members 120a and 120b until the guide pins 144 are pulled out, with the result that, as in the double-sided ferrule manufacturing method of embodiment 1, no positional deviation is generated between the members 120a and 120b, nor is any external force applied to the optical fibers 3 due to the positional deviation of the member 120a or 120b.

(Embodiment 3 of Double-Sided Ferrule Manufacturing Method)

The thermosetting adhesive in the above-described embodiments may, for example, be a two-liquid mixture type epoxy resin. However, when heating is effected in a high-temperature furnace like a Frilow furnace, a heat resistant epoxy resin is used. Further, the adhesive is not restricted to a thermosetting adhesive. It may also be, for example, an instantaneous adhesive. Further, it is not always necessary for the adhesive for fixing the member 120a or 120b to the optical fibers 3 to be the same as that for fixing the cut surfaces 140 of the members 120a and 120b to each other.

The members 120a and 120b are completely the same members. In this specification, they are interchangeable with each other.

(Embodiment 1 of Double-Sided Ferrule Manufacturing Method and Auxiliary Member)

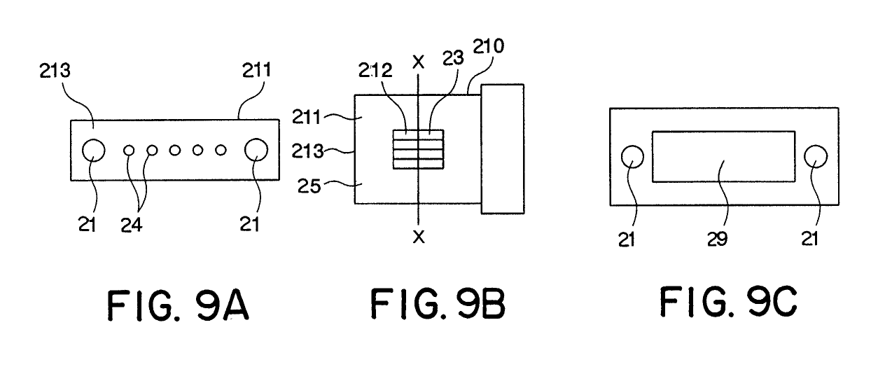

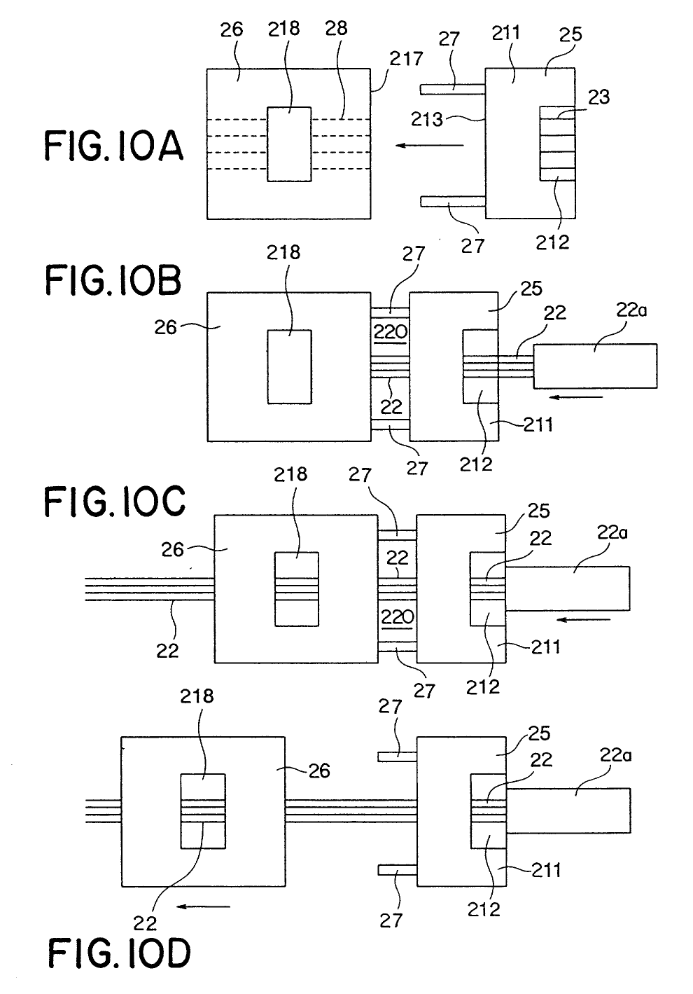

In this embodiment, an existing MT connector ferrule is divided to use a part of it as an auxiliary member for insertion, and optical fibers are inserted into a double-sided ferrule by utilizing the auxiliary member. This embodiment will be described with reference to FIGS. 9A through 9C and FIGS. 10A through 10D.

As shown in these drawings, an existing MT connector ferrule 210 is divided into two portions, and one of them is used as an auxiliary member 25. The existing MT connector ferrule 210 is equipped with guide pin insertion holes 21, an optical fiber insertion opening 29 into which optical fibers 22 can be inserted, guide grooves 23 for guiding the optical fibers 22, and optical fiber insertion holes 24 into which the bare optical fibers 22 (more specifically, individual optical fibers with the outer coating of the fiber ribbon 22a removed therefrom) can be inserted. In this embodiment, the ferrule 210 is cut along the line X-X (FIG. 9B) across the guide pin insertion holes 21 and the guide grooves 23 to divide it into an optical fiber insertion opening side portion and an optical fiber insertion hole side portion, of which the divisional ferrule 211 on the optical fiber insertion hole 24 side is used.

The above-mentioned division is effected at a position spaced apart from the joint end surface 213 of the ferrule 210 by, for example, approximately 3.5 mm. In this case, it is desirable for the divisional ferrule 211 on the optical fiber insertion hole 24 side to retain several mm of the U-grooves (guide grooves) 23 formed in front of the optical fiber insertion holes 24.

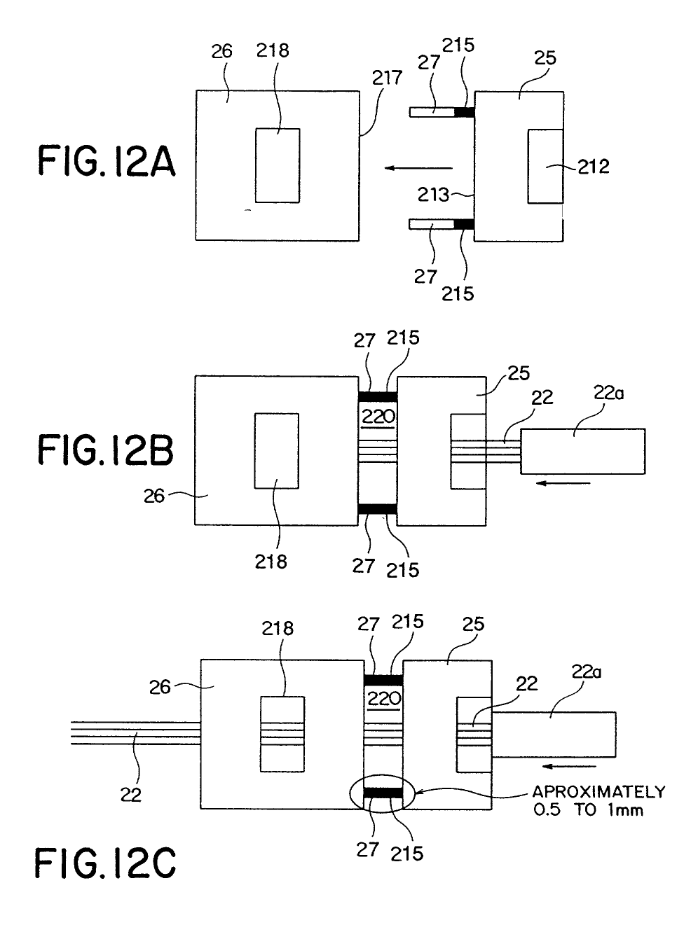

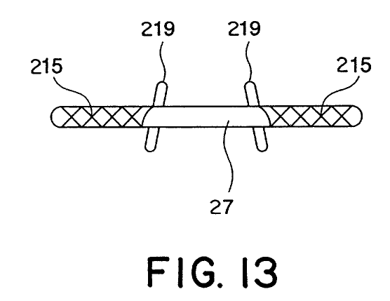

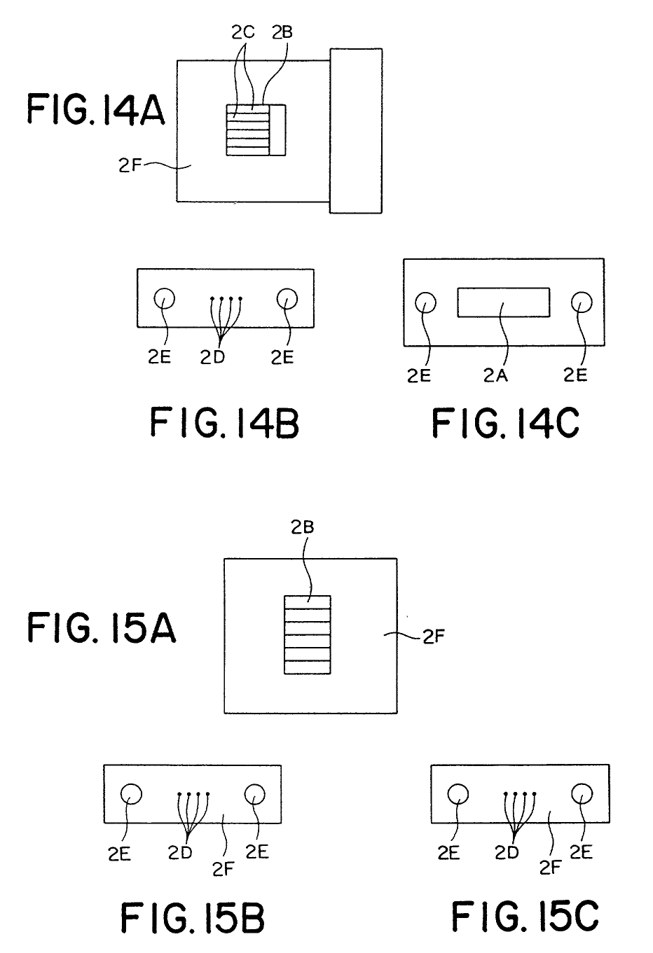

In the present invention, the divisional ferrule 211 is used as an auxiliary member 25. One axial ends of guide pins 27 (FIG. 13) are inserted into the guide pin insertion holes 21 of the auxiliary member 25 as shown in FIG. 12A, and the other axial ends of the guide pins 27 are caused to protrude outwardly from the joint end surface 213 of the auxiliary member 25. It is preferable that the protruding dimension of the guide pins 27 be not less than 1 mm. In this case, force-in knurled portions 215 of the guide pins 27 also protrude slightly from the auxiliary member 25. The guide pins 27 are fixed by adhesion to the guide pin insertion holes 21 of the auxiliary member 25, or fixed by forcing the knurled portions 215 formed on the guide pins 27 into the guide pin insertion holes 21.

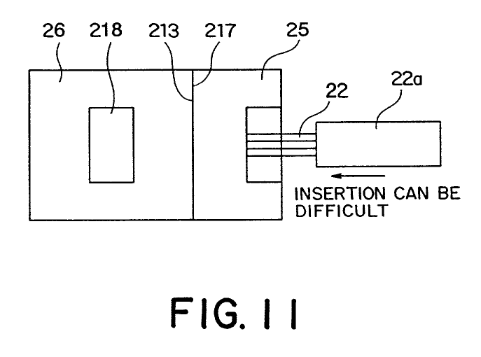

Next, a double-sided ferrule 26 is opposed to the joint end surface 213 of the auxiliary member 25, and the protruding ends of the guide pins 27 protruding from the auxiliary member 25 are inserted into the guide pin insertion holes 21 of the double-sided ferrule 26 and fixed thereto. This fixation is effected by an adhesive, or forcing the knurled portions 215 formed on the guide pins 27 into the guide pin insertion holes 21. In this case, it is preferable that the joint end surface 217 of the double-sided ferrule 26 and the joint end surface 213 of the auxiliary member 25 be opposed to each other with a gap 220 therebetween (The knurled portions 215 form the gap 220). If, as shown in FIG. 11, the two end surfaces are butting against each other with no gap therebetween, molding burr, dirt, etc. around the insertion holes of the end surfaces may be caught between the end surfaces to clog the optical fiber insertion holes, thereby constituting an obstruction to the insertion of the optical fibers into the optical fiber insertion holes. In view of this, a gap 220 of at least 0.5 mm is provided between the joint end surfaces 213 and 217, whereby it is possible to insert the optical fibers 22 without concern for burr or dirt, thus facilitating the insertion of the optical fibers 22 into the optical fiber insertion holes 28 of the double-sided ferrule 26.

The above-mentioned gap 220 is secured, for example, as follows: Insertion restricting portions 219 (FIG. 13) are formed at both ends of each guide pin 27, so that when one ends of the guide pins 27 are forced into the guide pin insertion holes 21 of the auxiliary member 25 until they are stopped (restricted) by the insertion restricting portions 219, the guide pins 27 protrude from the joint end surface 213 of the auxiliary member 25 by, for example, approximately 0.5 mm to 1 mm, and when the other ends of the guide pins 27 are forced into the guide pin insertion holes 21 of the double-sided ferrule 26 until they are stopped (restricted) by the insertion restricting portions 219, the gap 220 is automatically defined between the joint end surface 217 of the ferrule 26 and the joint end surface 213 of the auxiliary member 25. The structure of the insertion restricting portions 219 may be of various types. For example, outwardly protruding protrusions formed on the guide pins 27 may constitute the insertion restricting portions, or the end portions of the guide pins 27 may be made thinner than the central portions thereof, the boundary portions constituting the insertion restricting portions 219.

As described above, the double-sided ferrule 26 and the auxiliary member 25 are connected together with a gap therebetween, and then the optical fibers 22 from which the coating has been removed are caused to advance slowly along the guide grooves 23 of the auxiliary member 25 and are inserted into the optical fiber insertion holes 24 of the auxiliary member 25. The optical fibers 22 are further inserted so as to be passed through the fiber insertion holes 24 of the auxiliary member 25 and protrude beyond the holes, the protruding optical fibers 22 being inserted into the optical fiber insertion holes 28 of the double-sided ferrule 26. In this case, the auxiliary member 25 is one of the two portions obtained by dividing the MT connector ferrule 210, so that the optical fiber insertion holes 24 of the auxiliary member 25 are of the same accuracy as the optical fiber insertion holes 28 of the double-sided ferrule 26. Thus, the optical fibers can be smoothly inserted into the optical fiber insertion holes 28 of the double-sided ferrule 26.

After the above process, an adhesive is injected from the adhesive injection hole 218 of the double-sided ferrule 26 to fix the optical fibers 22 in the optical fiber insertion holes 28 of the double-sided ferrule 26. At this time, the double-sided ferrule 26 is caused to slide along the optical fibers 22 so that the adhesive may sufficiently flow into the optical fiber insertion holes 28. Next, as shown in FIG. 10D, the auxiliary member 25 and the double-sided ferrule 26 are separated from each other, and the optical fibers 22 are cut on the outer sides of the end surfaces of the double-sided ferrule 26, the end surfaces being polished together with the cut surfaces of the optical fibers 22 to complete a double-sided ferrule (product).

(Embodiment 2 of Double-Sided Ferrule Manufacturing Method and Auxiliary Member)

While in the above-described Embodiment 1 a portion of an existing ferrule obtained by dividing the same is used as the insertion auxiliary member 25, it is also possible in the present invention to use a newly prepared auxiliary member. In this case, an auxiliary member of the same structure as the auxiliary member of Embodiment 1 is prepared. That is, as shown in FIG. 10A, the auxiliary member is equipped with guide pin insertion holes 21, guide grooves 23 for individually guiding the bare optical fibers 22 from which the coating has been removed, optical fiber insertion holes 24 which are formed ahead of the guide grooves 23 and into which the optical fibers 22 can be individually inserted, and an adhesive injection hole 212 formed on the outer side of the guide grooves 23. This auxiliary member 25 is used in the same manner as the auxiliary member 25 of Embodiment 1 for insertion of the optical fibers 22 into the double-sided ferrule 26.

(Embodiment 1 of End Surface Polishing Method)

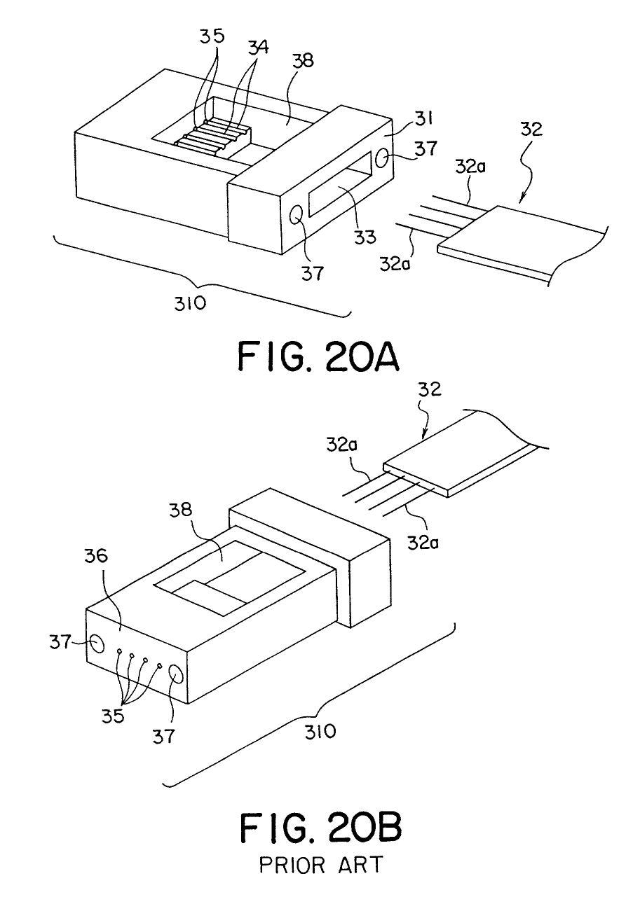

An optical connector ferrule end surface polishing method according to an embodiment of the present invention will be described. The optical connector ferrule end surface polishing method of the present invention is suitable for polishing the end surfaces of an optical connector ferrule having a structure different from that of the existing ferrule shown in FIGS. 20A and 20B. Thus, the structure of an optical connector ferrule whose end surfaces are polished by the optical connector ferrule end surface polishing method of the present invention will be first described in detail, and then the optical connector ferrule end surface polishing method of the present invention will be described in detail.

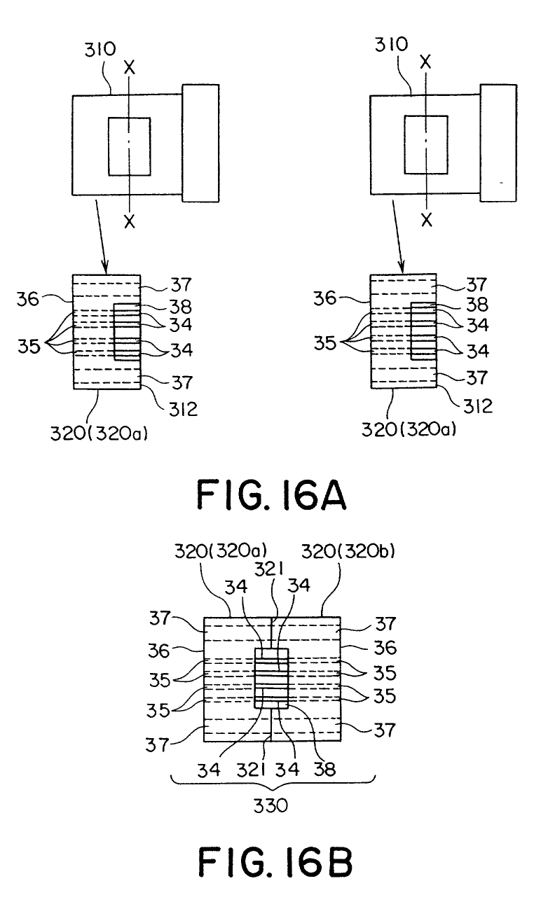

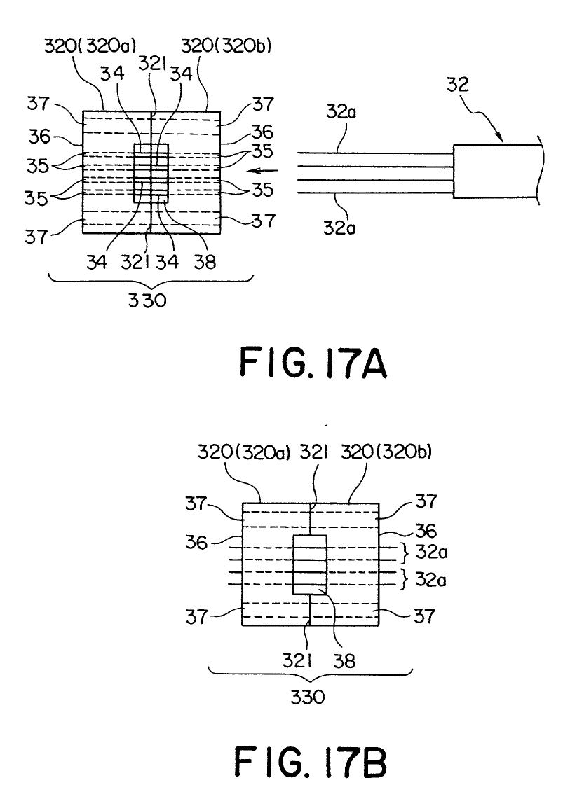

The following is an example of an optical connector ferrule suited for end surface polishing by the optical connector ferrule end surface polishing method of the present invention. As shown in FIG. 16A, two existing ferrules 310 as shown in FIGS. 20A and 20B are prepared, and each ferrule 310 is cut along the dotted line X-X of FIG. 16A in the lateral direction (the direction in which the fiber minute holes 35 of shown in FIG. 20A are arranged) to obtain two members 320 each equipped with a joint end surface 36. Next, a thermosetting adhesive is applied to both or one of the cut surfaces 321 of the two members 320 (320a and 320b), and, as shown in FIG. 16B, the cut surfaces 321 are butting against each other such that the guide grooves 34 and the guide pin holes 38 remaining in the members 320a and 320b communicate each other and that their fiber minute holes 35 communicate with each other through the guide grooves 34. Thereafter, as shown in FIG. 17A, bare optical fibers (more specifically, individual optical fibers with the outer coating of the fiber ribbon 32 removed therefrom) 32a are inserted into the fiber minute holes 35 of the member 320b from the side of the joint end surface 36 of the member 320b, and the optical fibers 32a are inserted into the fiber minute holes 35 of the other member 320a communicating with the fiber minute holes 35 of the member 320b. Thereafter, the surplus portions of the optical fibers 32a are cut off to attain the state as shown in FIG. 17B. Here, the insertion length is adjusted such that both ends of the optical fibers 32a inserted into the fiber minute holes 35 communicating with each other protrude outwardly from the respective joint end surfaces 36. Next, an adhesive is injected into the adhesive injection hole 38, and this adhesive and the adhesive previously applied to the cut surface 321 are cured by heating, whereby the butting cut surfaces 321 are fixed to each other, and the fiber ribbon 32 is fixed to the members 320a and 320b by adhesion. In this way, an optical connector is obtained in which optical fibers 32a are inserted and fixed in the ferrule 330 having two joint end surfaces 36 as shown in FIG. 17B. In FIG. 17B, the guide grooves 34 and the fiber minute holes 35 are omitted.

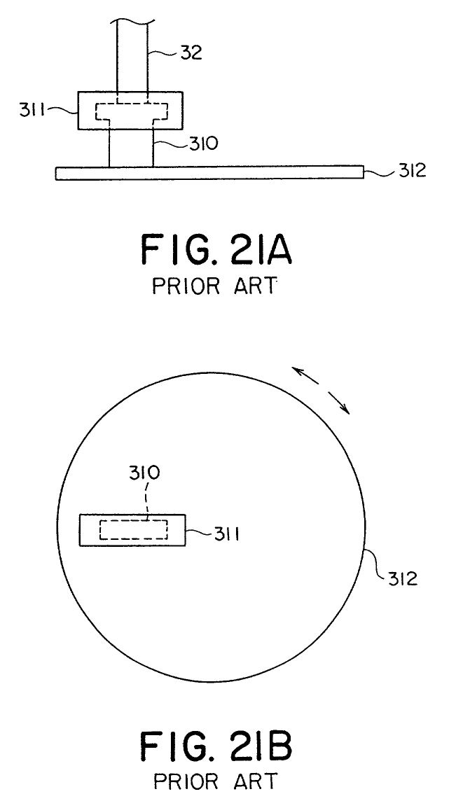

The optical connector end surface polishing method of the present invention is suitable for polishing the joint end surfaces 36 of the ferrule 330 as shown in FIG. 17B. If both or one of the joint end surfaces 36 of the ferrule 330 formed by gluing two members 320a and 320b to each other, as shown in FIG. 17B, is polished by the conventional method shown in FIGS. 21A and 21B, a shearing force is applied to the cut surfaces 321 of the members 320a and 320b glued to each other, so that there is a danger of the cut surfaces 321 being separated from each other.

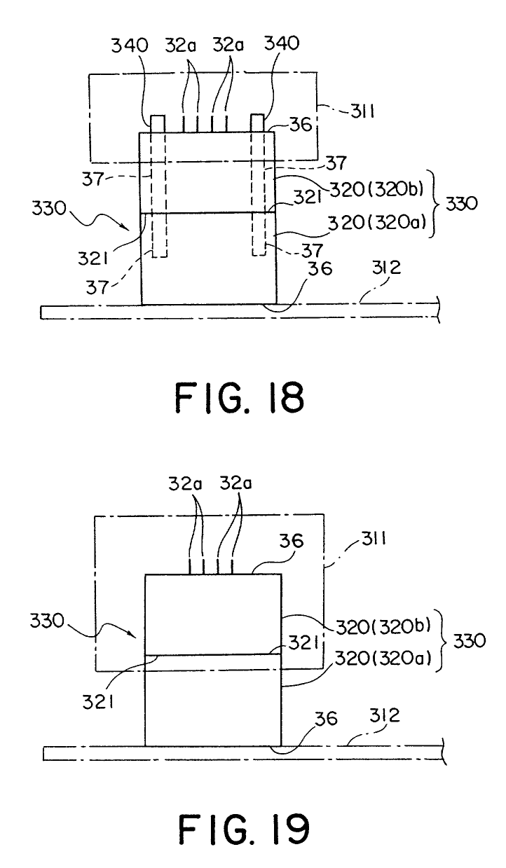

In view of this, as shown in FIG. 18, in the optical connector end surface polishing method of the present invention, reinforcing members 340 (FIG. 18) are inserted into the guide pin holes 37 (FIG. 17B) of the ferrule 330 set to a fixing jig 311 of a polishing machine similar to that shown in FIGS. 21A and 21B so as to extend through the members 320a and 320b (i.e., so as to extend from the guide pin holes 37 of one member 320a or 320b to the guide pin holes 37 of the other member 320b or 320a. With this arrangement, when polishing one of the joint end surfaces 36 of the ferrule 330, if only the member 320b or 320a other than the member 320a or 320b, in which the joint end surface 36 is formed, is set by the fixing jig 311, there is no fear that the cut surfaces 321 of the members 320a and 320b glued to each other will be separated from each other by a shearing force. FIG. 18 shows a case in which the reinforcing members extend from the guide pin holes 37 of the member 320b to the guide pin holes 37 of the member 320a and in which only the member 320b is fixed by the fixing jig 311 to polish the joint end surface 36 formed on the member 320a.

There are no particular limitations regarding the reinforcing members 340 as long as they can be inserted into the guide pin holes 37 and have sufficient strength. In this embodiment,the guide pins inserted into the guide pin holes of both the ferrules communicating with each other for the purpose of positioning of the guide when connecting the optical connector ferrules are used as the reinforcing members. Such guide pins have conventionally been used for the connection of an optical connector ferrule. As the reinforcing members, ceramic members or the like having the same structure as the guide pins can be used.

As shown in FIG. 19, by collectively fixing the members 320a and 320b by the fixing jig 311, it is possible to obtain the same effect as in the case in which reinforcement is effected by the reinforcing members 340. That is, while in FIG. 18 only the member 320b is set by the fixing jig 311, it is also possible, as shown in FIG. 19, to collectively set both the members 320a and 320b by the fixing jig astride the end surfaces of them, whereby, if the joint end surface 36 of one member 320a is held in contact with the surface of a polishing disc 311 to polish the end surface 37, there is no fear that the cut surfaces of the members 320a and 320b glued together will be separated from each other by the shearing force.

(Embodiment 1 of Optical Connector Assembling Method)

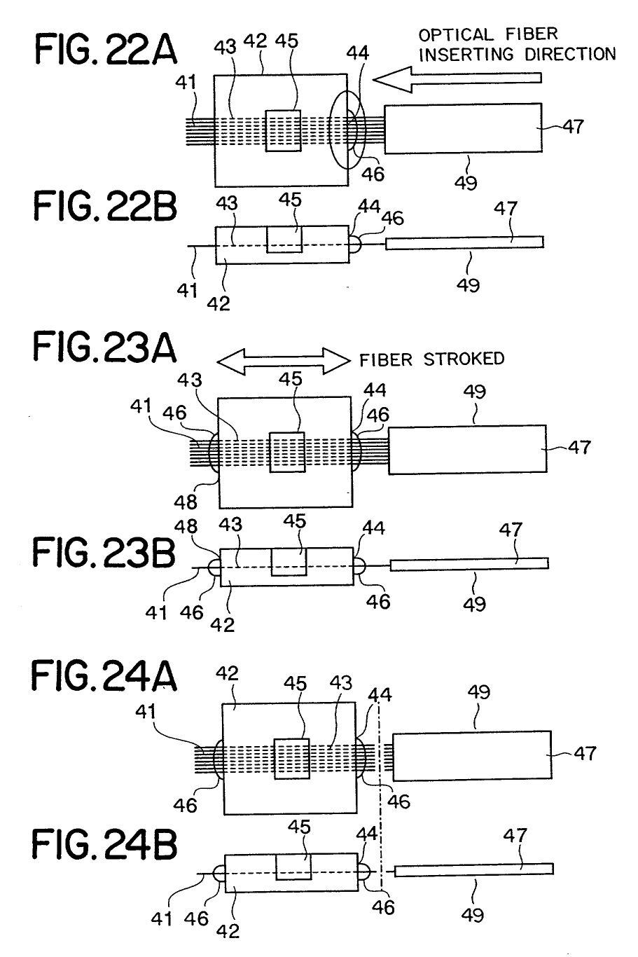

A first embodiment of the optical connector assembling method of the present invention will be described with reference to FIGS. 22A and 22B. In this assembling method, before inserting bare optical fibers 41 (bare optical fibers) from which an end portion of a coating 47 of a fiber ribbon 49 has been removed into optical fiber insertion holes 43, an adhesive 46 is injected into inlets 44 of the optical fiber insertion holes 43 and an injection window 45 communicating with the optical fiber insertion holes 43. Thereafter, the optical fibers 41 are inserted into the optical fiber insertion holes 43 from the inlets 44, and the adhesive 46 is forced into the optical fiber insertion holes 43. By this forcing-in, the adhesive 46 is spread across the interior of the optical fiber insertion holes 43, and the adhesive 46 sufficiently fills the gaps between the optical fibers 41 and the optical fiber insertion holes 43, thereby enlarging the adhesion area of the adhesive 46 to enhance the adhesion strength. In this case, it is also possible to inject the adhesive 46 into the optical fiber insertion holes 43 from the injection window 45 before the insertion of the optical fibers.

After inserting the optical fibers 41 into the optical fiber 43 as described above, thermosetting of the adhesive 46 is effected. Upon temperature rise, the adhesive 46 once undergoes a reduction in viscosity and then starts to cure. Because of the reduction in viscosity, the adhesive 46 is displaced from the position of application by several μm. As a result, a tensile force is applied to the optical fibers 41. In this case, the plurality of optical fibers 41 are coated with the coatings 47 into a tape-like structure, so that free movement of the individual optical fibers 41 is restricted. Thus, when the adhesive 46 is thermally set, an excessive force is applied to the optical fibers 41 to generate distortion in the adhesive 46. To remove this distortion, in accordance with the present invention, the coating 47 is cut as shown in FIGS. 24A and 24B before allowing the adhesive to be thermally set. With this arrangement, the individual optical fibers 41 inserted into the optical fiber insertion holes 43 are released from the restriction by the coating 47 and can move freely, thus restraining generation of distortion.

Further, in the present invention, to eliminate the distortion of the adhesive 46 generated at the time of thermosetting, the adhesive 46 is heated at a temperature not lower than the glass-transition temperature (Tg) after the curing of the adhesive 46. If a temperature not lower than Tg is applied, the adhesive 46 is softened, and the distortion can be eliminated. When effecting cooling from a temperature not lower than Tg, the adhesive 46 is restored to room temperature over a period of time long enough not to generate distortion in the adhesive, e.g., 30 minutes or more. Abrupt cooling is to be avoided since it would involve generation of distortion in the adhesive again at the time of curing.

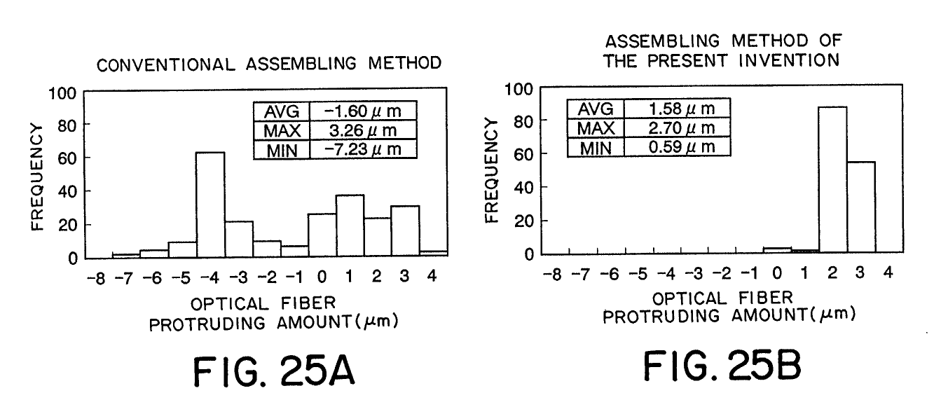

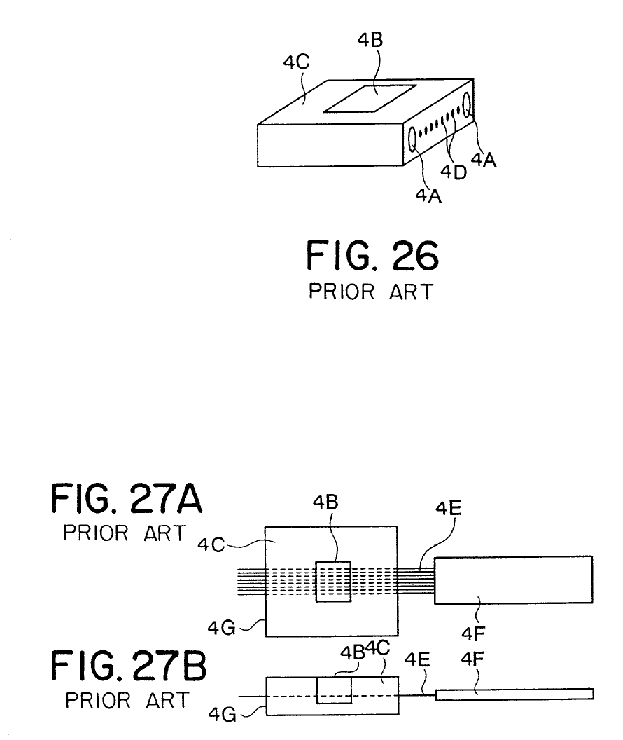

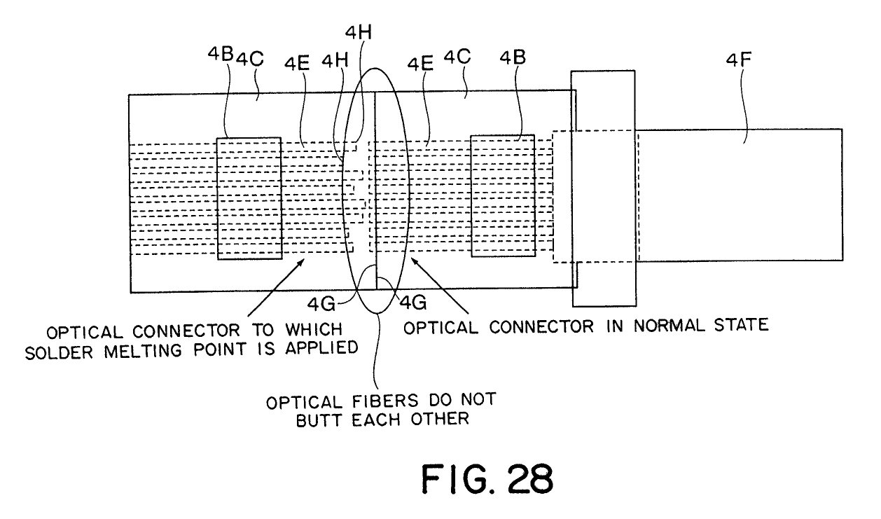

Usually, when assembling the optical connector, the end surfaces of the optical fibers 41 protrude beyond the end surface of the ferrule 42 by approximately 2 μm. In the case of an optical connector assembled by the conventional assembling method, when solder melting point is applied to the ferrule, the optical fibers 41 are retracted from the ferrule end surface by 7.23 μm at maximum, as shown in FIG. 25A, whereas, in the case of an optical connector assembled by the assembling method of the present invention, a protruding length of 0.59 μm at minimum is ensured as shown in FIG. 25B, and the optical fibers 41 are not retracted to the inner side of the ferrule end surface. Thus, the PC connection of the optical fibers is reliably effected, and the connection state is maintained even if heat is applied, there being no deterioration in connection loss. In FIGS. 25A and 25B, the positive optical fiber protruding amounts indicate the amounts by which the optical fibers protrude from the joint end surface, and the negative amounts indicate the amounts by which the optical connectors are retracted from the joint end surfaces of the optical connectors. Further, in FIGS. 25A and 25B, the frequency indicates the optical number assembly number, AVG indicates the average value, MAX indicates the maximum protruding amount, and MIN indicates the maximum retracting amount.

(Embodiment 2 of Optical Connector Assembling Method)

A second embodiment of the optical connector assembling method of the present invention will be described with reference to FIG. 23A. In this assembling method, an adhesive 46 is applied to the inlets 44 side and the outlets 48 side of the optical fiber insertion holes 43 before inserting the optical fibers 41 (bare fibers) from which an end portion of the coating 47 of the fiber ribbon 49 has been removed into the optical fiber insertion holes 43. Thereafter, the optical fibers 41 are inserted into the optical fiber insertion holes 43, and the optical fibers 41 are reciprocated in the inserting direction (hereinafter referred to as “stroked”). By stroking the optical fibers 41, the adhesive 46 applied to the inlets 44 side and the outlets 48 side reliably enter the optical fiber insertion holes 43 and is spread across the optical fiber insertion holes 43, whereby the adhesion area of the adhesive 46 increases, thus enabling the optical fibers 41 to be reliably fixed inside the optical fiber insertion holes 43. In this case also, it is possible to inject the adhesive 46 into the optical fiber insertion holes 43 from the injection window 45 before inserting the optical fibers.

As in Embodiment 1, in Embodiment 2, the adhesive 46 is thermally set after cutting the tape-like coating 47, heating is effected at a temperature not lower than Tg, and the optical fibers are restored to room temperature in not less than 30 minutes after the heating. As in the prior art, the end surface of the ferrule 42 is polished after fixing the optical fibers to the ferrule 42 and cutting off the portion of the coating 47 on the outer side of the ferrule 42.

(Embodiment 1 of Guide Pin)

An embodiment of the guide pins of the present invention will be described. The guide pins of this embodiment are inserted into the guide pin holes of the optical connectors communicating with each other when connecting a pair of optical connectors so as to extend through both of the optical connectors, thereby effecting alignment on the two optical connectors. In the following, an embodiment of the guide pin of the present invention will be described.

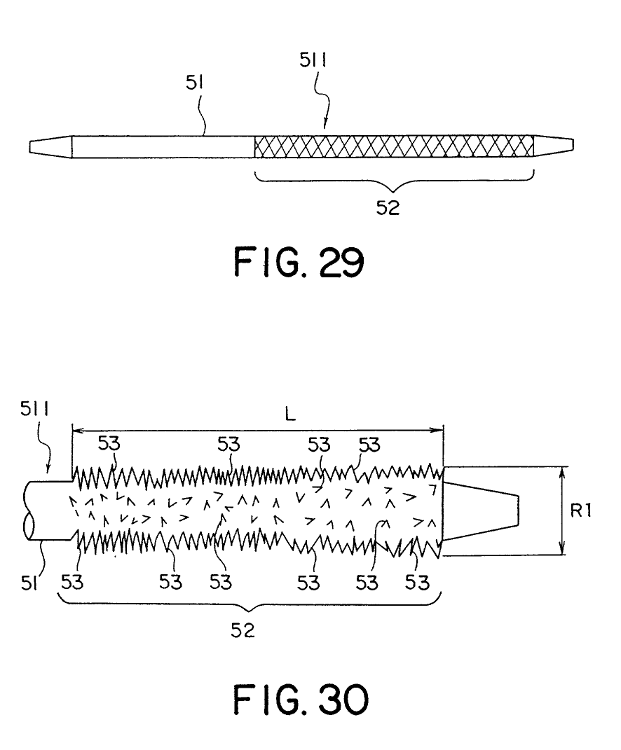

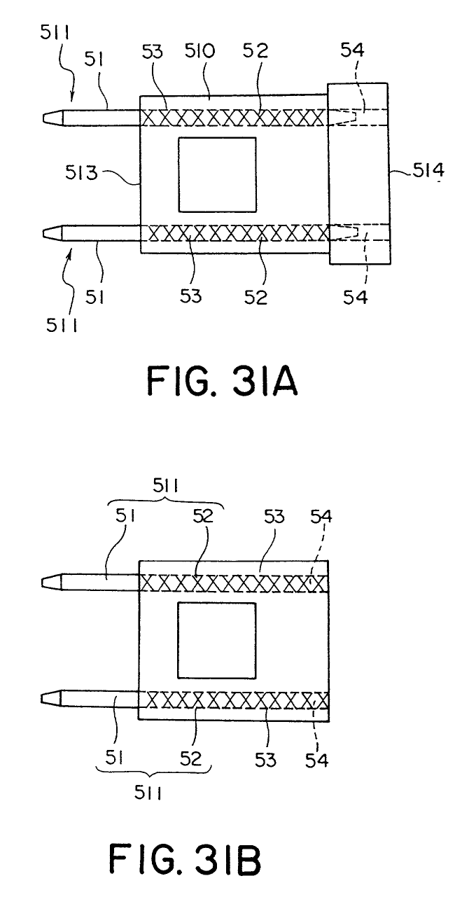

As shown in FIG. 29, in the guide pin of this embodiment, a fixing portion 52 (the shaded portion of FIG. 29) is formed in a longitudinal part of a metal pin 51 with tapered ends. The fixing portion 52 is formed by roughening one longitudinal end portion of the metal pin 51, forming a large number of sharp engagement protrusions 53 as shown in FIG. 30. The length L of the fixing portion 52 shown in FIG. 30 is 4 mm. Further, assuming that the maximum outer diameter of the fixing portion 52 is R1 (μm), and that the inner diameter of the guide pin hole (not shown) of the optical connector into which the guide pin is inserted is R2 (μm), the following relationship holds good: R2≦R1≦R2+10 μm. Thus, when, as shown in FIG. 31A, the fixing portions 52 of the guide pins 511 of the present invention are inserted (forced) into the guide pin holes 54 of the optical connector 510, the engagement protrusions 53 are engaged with the inner peripheral surface 55 of the guide pin holes 54, thereby fixing the guide pins 511 to the optical connector 510.

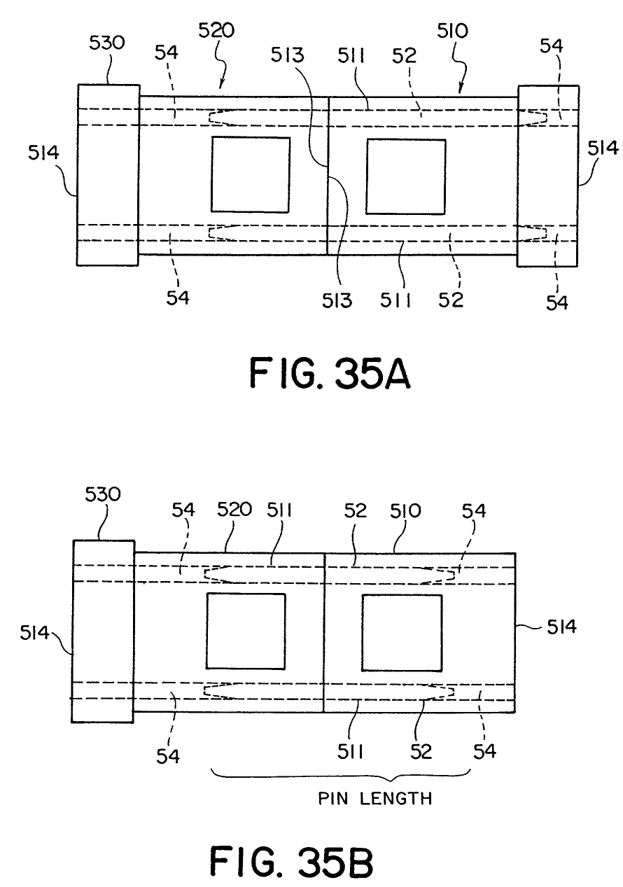

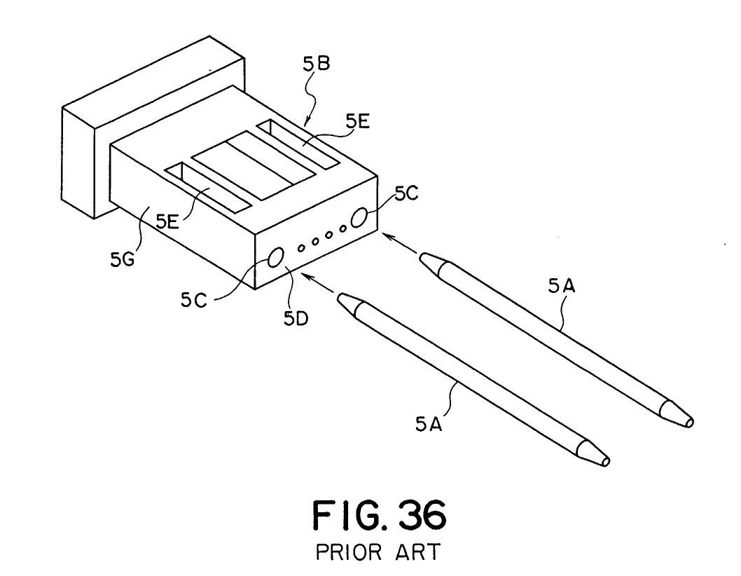

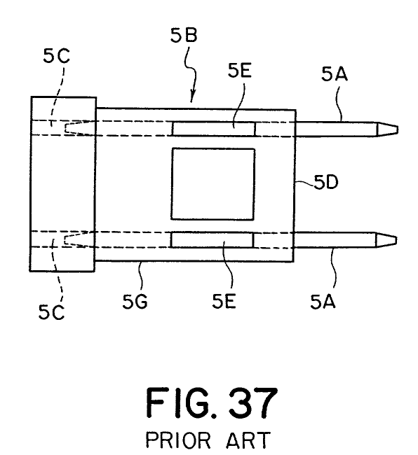

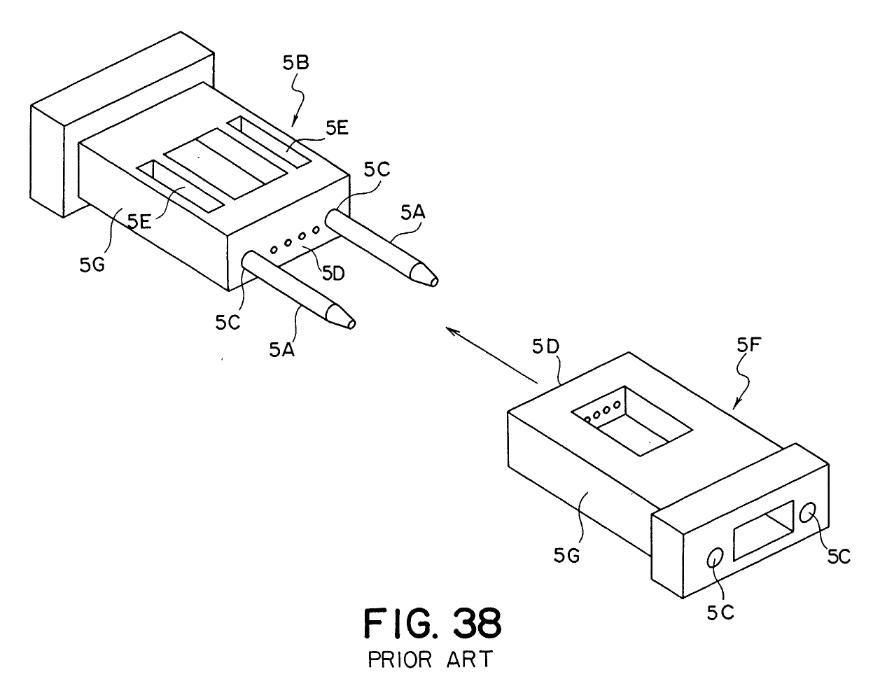

When the length L of the fixing portion 52 is 4 mm, and the maximum diameter R1 (μm) satisfies the relationship: R2≦R1≦R2+10 μm, the guide pins 511 do not come out of the guide pin holes 54 even if a tensile load of approximately 1 to 8 kgf is applied to the guide pins 511 inserted into the guide pin holes 54. However, for the guide pins to be inserted into the guide pin holes 54 in a satisfactory manner, it is desirable that the maximum outer diameter R1 (μm) of the fixing portion 52 be not less than R2+1 μm but not more than R2+4 μm. In this case, the guide pins 511 do not come out of the guide pin holes 54 even if a tensile load of approximately 3 to 7 kgf is applied to the guide pins 511 inserted into the guide pin holes 54. It is also possible to force the guide pins 511 into the guide pin holes 54 of an optical connector 510 of a structure as shown in FIG. 31B. As in the case of FIG. 35A, the guide pins 511 do not come out of the guide pin holes 54 in this case.

(Embodiment 2 of Guide Pin)

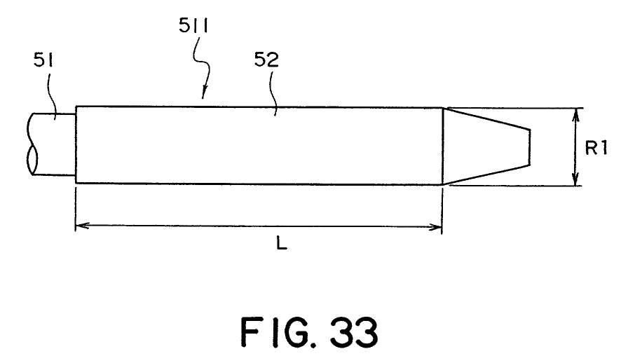

Another embodiment of the guide pin of the present invention will be described. The basic structure of the guide pin of this embodiment is the same as that of Embodiment 1. This embodiment differs from Embodiment 1 in that, as shown in FIG. 33, a fixing portion 52 with a relatively large outer diameter is formed in a longitudinal part of a metal pin 51. When this fixing portion 52 is forced into the guide pin hole (not shown) of an optical connector, the guide pint 511 is fixed to the optical connector.

The length L of the fixing portion 52 shown in FIG. 33 is 4 mm. Assuming that the maximum outer diameter of the fixing portion 52 is R1 (μm), and that the inner diameter of the guide pin hole (not shown) of the optical connector into which the guide pin 511 is inserted is R2 (μm), the following relationship holds good: R2≦R1≦R2+2 μm. Thus, when, as shown in FIG. 31, the fixing portions 52 of the guide pins 511 of the present invention shown in FIG. 33 are inserted (forced) into the guide pin holes 54 of the optical connector 510, the guide pins 511 are fixed to the optical connector 510.

When the length L of the fixing portion 52 is 4 mm, and the maximum diameter R1 (μm) satisfies the relationship: R2≦R1≦R2+2 μm, the guide pins 511 do not come out of the guide pin holes 54 even if a tensile load of approximately 0.5 to 6.0 kgf is applied to the guide pins 511 inserted into the guide pin holes 54. However, for the guide pins to be inserted into the guide pin holes 54 in a satisfactory manner, it is desirable that the maximum outer diameter R1 (μm) of the fixing portion 52 be approximately R2+0.5. In this case, the guide pins 511 do not come out of the guide pin holes 54 even if a tensile load of approximately 0.5 to 4.0 kgf is applied to the guide pins 511 inserted into the guide pin holes 54.

(Embodiment 1 of Optical Connector Connecting Method)

In the optical connector connecting method of the present invention, a pair of optical connectors are connected by using the above-described guide pins of the present invention. An embodiment of the optical connector connecting method of the present invention will be described.

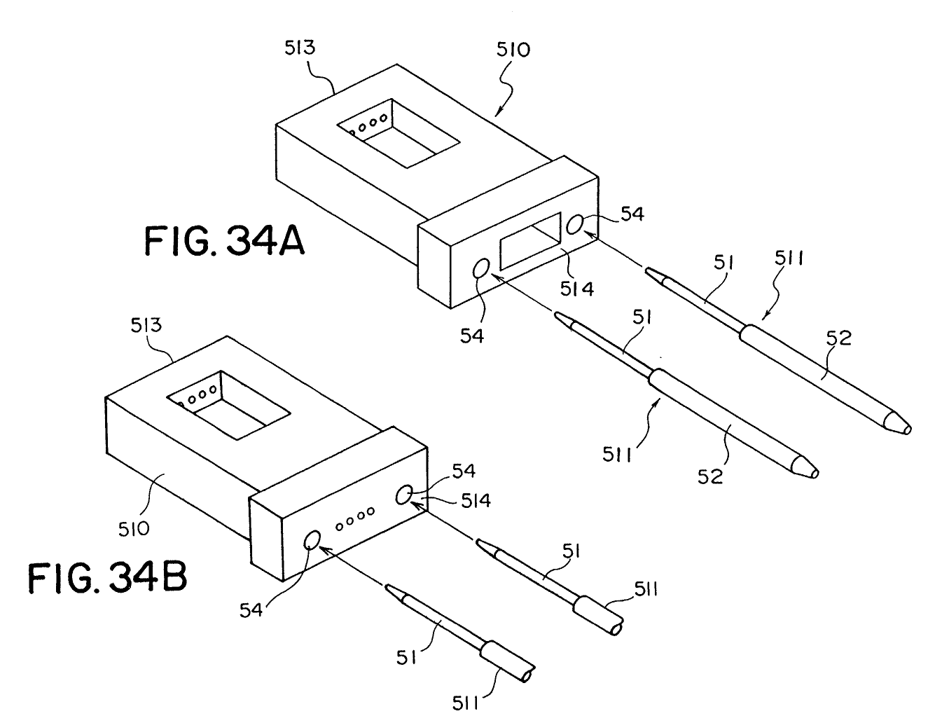

(1) As shown in FIGS. 34A and 34B, the guide pins 511 according to Embodiment 1 of the present invention described above are individually inserted into two guide pin holes 54 of one optical connector 510 from the end surface 514 side on the opposite side of the joint end surface 513 of this optical connector 510. In this process, the insertion into the guide pin holes 54 is effected starting with the forward end side (the opposite side of the fixing portions 52) of the guide pins 511. Although not shown, optical fibers are inserted and secured in the optical connector 510. The joint end surface 513 has already been polished.

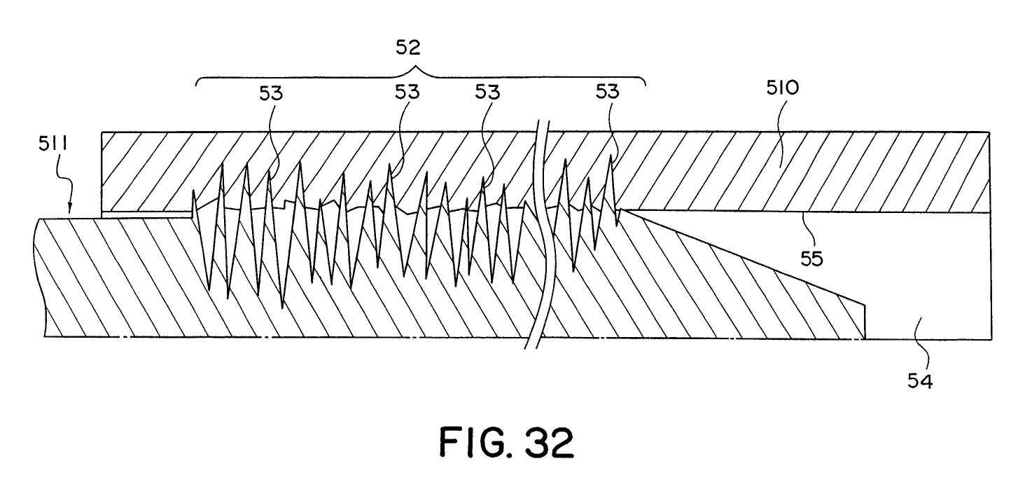

(2) The guide pins 511 are further inserted into the guide pin holes 54, and, as shown in FIG. 31, the forward ends of the guide pins 511 are caused to protrude outwardly from the joint end surface 513 of the optical connector 510 by an amount not less than a predetermined length. In this process, the fixing portions 52 of the guide pins 511 should not be exposed on the outer side of the joint end surface 513. When the guide pins 511 are inserted into the guide pin holes 54 up to the positions shown in FIG. 31, the fixing portions 52 of the guide pins 511 are forced into the guide pin holes 54. Then, as described above, the engagement protrusions 53 of the fixing portions 52 are engaged with the inner peripheral surfaces 55 of the guide pin holes 54, and the guide pins 511 are fixed to the optical connector 510 (FIG. 32). When the guide pins 511 are inserted into the guide pin holes 54 until the forward ends thereof protrude outwardly from the joint end surface 513 by an amount not less than a predetermined length, the rear ends of the guide pins 511 are retracted into the guide pin holes 54 (FIG. 31).

(3) As shown in FIG. 35A, the forward ends of the guide pins 511 outwardly protruding from the joint end surface 513 of the optical connector 510 are inserted into the guide pin holes 54 of the other optical connector 520, and the joint end surfaces 513 of the optical connectors 510 and 520 are butting against each other. Although not shown, optical fibers are also inserted and secured in the other optical connector 520. Further, the joint end surfaces 513 have already been polished.

In this way, the optical fibers inserted and secured in the two optical connectors 510 and 520 are optically connected. If the guide pins 511 are inserted into the guide pin holes 54 from the joint end surface 513 side of the optical connector 510, the guide pins 511 can be fixed by engaging the engagement protrusions 53 with the inner peripheral surfaces 55 of the guide pin holes 54. In this case, however, there is a fear that the edges of the guide pin holes 54 will chip when forcing the fixing portions 52 into the guide pin holes 54, the chips remaining between the joint end surfaces 513 of the two optical connectors 510 and 520 butting against each other. Thus, it is desirable for the guide pins 511 to be inserted into the guide pin holes 54 from the end surface 514 side on the opposite side of the joint end surface 513 of the optical connector 510.

In the optical connector connecting method of the present invention, it is also possible to connect an optical connector 520 having a flange 530 with a double-sided connector 510 as shown in FIG. 35B. As in the case of FIG. 35A, the guide pins 511 are forced in for connection. In this case, it is also possible to previously force the guide pins 511 into the flanged connector 520 for fixation or force them into the double-sided ferrule for fixation.

(Embodiment 2 of Optical Connector Connecting Method)

Another embodiment of the optical connector connecting method of the present invention will be described. The basic structure of the optical connector connecting method of this embodiment is the same as that of the optical connector connecting method of Embodiment 1. This embodiment differs from Embodiment 1 in that the guide pin 511 shown in FIG. 33 is used. More specifically, the fixing portions 52 of the guide pins 511 shown in FIG. 33 are forced into the guide pin holes 54 of the optical connector 510 shown in FIG. 34 to fix the guide pins 511 to the optical connector 510. As in the above-described case, it is desirable for the guide pins 511 to be inserted into the guide pin holes 54 from the end surface 514 side on the opposite side of the joint end surface 513 of the optical connector 510.

Effects of the Invention

1. The double-sided ferrule manufacturing method according to one of Claims 1 through 3 provides the following advantages:

(1) Since a new ferrule equipped with two joint end surfaces is produced by utilizing an existing ferrule, there is no need to produce a new mold, thereby achieving reduction in the production cost. In particular, the ferrule equipped with two joint end surfaces is required to be equipped with fiber minute holes communicating with the joint end surfaces, and the mold for producing such a ferrule inevitably has a complicated structure and is expensive. Thus, the double-sided ferrule manufacturing method of the present invention, which requires no complicated and expensive mold, helps to achieve a substantial reduction in production cost.

(2) In the case in which, when gluing the cut surfaces of two members equipped with joint end surface to each other, guide pins are inserted into the guide pin holes of these members for effecting positioning on the two members, it is possible to fix the two members to each other without involving any positional deviation.

(3) When oil is previously applied to the outer peripheral surfaces of the guide pins, the guide pins are prevented from being fixed to the member by the oil, so that the guide pins can be easily pulled out of the member afterwards. Thus, it is possible to produce a ferrule with no guide pins.

2. The double-sided ferrule manufacturing method according to one of Claims 4 through 9 provides the following advantages:

(1) The double-sided ferrule manufacturing method according to Claim 4 uses an auxiliary member equipped with guide pin insertion holes, guide grooves for guiding optical fibers, and optical fiber insertion holes into which the optical fibers can be inserted, so that its optical fiber insertion holes coincide with those of the double-sided ferrule, and the optical fibers can be inserted into the optical fiber insertion holes of the double-sided ferrule easily and reliably.

(2) In the double-sided ferrule manufacturing method according to Claim 5, an existing MT connector ferrule is divided into two portions, and one of them is used as an auxiliary member, so that the dimensional accuracy of the optical fiber insertion holes coincides with that of the optical fiber insertion holes of the double-sided ferrule, making it possible for the optical fibers to be inserted into the optical fiber insertion holes of the double-sided ferrule easily and reliably.

(3) In the double-sided ferrule manufacturing method according to Claim 6, the auxiliary member and the double-sided ferrule are connected to each other so as to be opposed to each other with a gap therebetween, so that there is no fear that molding burr on the end surfaces of the auxiliary member and the double-sided ferrule will be occurred and dirt will be caught between them. Therefore, the optical fiber insertion holes are not clogged by the burr or dirt, and the optical fibers can be inserted into the optical fiber insertion holes smoothly and reliably.

(4) The double-sided ferrule manufacturing method according to Claim 7 uses a guide pin equipped with a forcing-in preventing portion, so that it is possible to reliably secure a gap between the auxiliary member and the double-sided ferrule, making it possible to reliably achieve the effect of Claim 6.

(5) The auxiliary member according to Claim 8 is equipped with guide pin insertion holes, guide grooves for individually guiding optical fibers from which coating has been removed, and optical fiber insertion holes which are formed ahead of the guide grooves and into which the optical fibers can be individually inserted, so that the optical fibers can be easily inserted into the optical fiber insertion holes of the auxiliary member. Further, by causing the optical fibers to extend through the optical fiber insertion holes of the auxiliary member, the optical fibers can be inserted into the optical fiber insertion holes of the double-sided ferrule as they are, thus further facilitating the insertion of the optical fibers into the minute optical fiber insertion holes.

(6) According to Claim 9, an existing MT connector ferrule is divided into two portions, and one of them is used as an auxiliary member, so that it is possible to provide an inexpensive auxiliary member which is easy to produce. Further, the dimensional accuracy of the MT connector ferrule is the same as that of the double-sided ferrule, so that the optical fibers can be inserted into the optical fiber insertion holes easily and reliably.

3. The optical connector ferrule end surface polishing method according to Claim 10 provides the following advantages:

(1) When polishing the end surface of an optical connector ferrule formed by gluing the end surfaces of two members to each other, reinforcing members are inserted into the guide pin holes of the two members communicating with each other, so that if an external force due to polishing is applied to the ferrule, there is no fear that the end surfaces of the two members will be separated from each other by the external force.

(2) The positions of the reinforcing members inserted into the guide pin holes of the two members communicating with each other can be set arbitrarily, so that the reinforcing members are not in the way when performing polishing.

4. The optical connector ferrule end surface polishing method according to Claim 11 provides the following advantage:

(1) When polishing the end surface of an optical connector ferrule formed by gluing the end surfaces of two members to each other, both of the members glued together are fixed by a fixing member astride the end surfaces of them, so that if an external force due to polishing is applied to the ferrule, there is no fear that the end surfaces of the two members will be separated from each other by the external force.

5. In the optical connector assembling method according to Claim 12 or 13, the adhesive sufficiently fills the spaces between the optical fibers and the optical fiber insertion holes, and the adhesion area by the adhesive is enlarged, thereby enhancing the adhesion strength.

6. In accordance with the optical connector assembling method according to claim 14, the optical fibers are released from the restriction by the coating and can move freely, so that generation of distortion at the time of thermosetting of the adhesive is restrained. Thus, PC connection can be effected in a satisfactory manner, and the connection loss is reduced.

7. In accordance with the optical connector assembling method according to Claim 15, after the curing of the adhesive, the adhesive is heated at a temperature not lower than Tg to soften the adhesive, so that the distortion generated at the time of thermosetting of the adhesive is eliminated, PC connection is effected in a satisfactory manner, and the connection loss is reduced.

8. In the optical connector according to Claim 16, the optical fibers are reliably glued to the ferrule.

9. In the guide pin according to Claim 17, a longitudinal portion is formed as a fixing portion with a relatively large diameter, and when the fixing portion is forced into a guide pin hole of an optical connector, it is fixed to the optical connector, thereby providing the following advantages:

(1) There is no need to provide the optical connector with an adhesive injection hole for injecting the adhesive for fixing the guide pins into the guide pin holes.

(2) The guide pin can also be fixed to an optical connector equipped with no adhesive injection hole described above.

(3) The guide pin can be fixed to the optical connector solely by forcing the fixing portion into the guide pin hole, so that the guide pin can be mounted to the optical connector in a short time. As a result, the optical connector connecting operation as a whole is facilitated, and the requisite time is shortened.

10. In the guide pin according to Claim 18, the outer peripheral surface of a longitudinal portion is formed as a fixing portion with a plurality of engagement protrusions, and when the fixing portion is forced into a guide pin hole of an optical connector, the engagement protrusions are engaged with the inner peripheral surface of the guide pin hole to thereby fix the guide pin to the optical connector, whereby the following advantages are provided:

(1) There is no need to provide the optical connector with an adhesive injection hole for injecting the adhesive for fixing the guide pins into the guide pin holes.

(2) The guide pin can also be fixed to an optical connector equipped with no adhesive injection hole described above.

(3) The guide pin can be fixed to the optical connector solely by forcing the fixing portion into the guide pin hole, so that the guide pin can be mounted to the optical connector in a short time. As a result, the optical connector connecting operation as a whole is facilitated, and the requisite time is shortened.

11. In the guide pin according to Claim 19 or 20, the diameter R1 (μm) of the fixing portion and the diameter R2 (μm) of the guide pin hole of the optical connector are in a predetermined relationship, thereby providing the following advantage:

(1) By forcing the fixing portion into the guide pin hole, it is possible to obtain a necessary and sufficient fixing force. Thus, if a tensile load that can be anticipated within the normal range of use is applied to the guide pin inserted into the guide pin hole, the guide pin does not come out of the guide pin hole.

12. In the optical connector connecting method according to Claim 21, the guide pin is inserted from the end surface side of the optical connector on the opposite side of the joint end surface thereof, thereby providing the following advantage:

(1) If the peripheral edge of the guide pin hole chips when inserting or forcing the guide pin into the guide pin hole, there is no fear that the chips will remain between the joint end surfaces of the two optical connectors butting against each other. Thus, the connection loss is not increased by the chips remaining between the joint end surfaces.

What is claimed is:

1. A double-sided ferrule manufacturing method comprising the steps of: preparing a ferrule forming an insertion opening which allows insertion of a fiber ribbon in one end surface of a ferrule; arranging fiber minute holes ahead of the insertion opening, optical fibers obtained by removing an end portion of the fiber ribbon inserted into the insertion opening being capable of being inserted into the fiber minute holes; forming the other end surface of the ferrule as a joint end surface in which the end surfaces of the optical fibers inserted into the fiber minute holes can be exposed; cutting the ferrule at some midpoint in the fiber ribbon inserting direction in the direction in which the fiber minute holes are arranged to thereby form a member equipped with the joint end surface; preparing two members each equipped with such a joint end surface; and causing the cut surfaces of the two members to butt against each other and gluing them together to thereby form a ferrule having two joint end surfaces.

2. A double-sided ferrule manufacturing method according to claim 1, wherein a guide pin is inserted into guide pin holes of the two members communicating with each other by butting the cut surfaces against each other to effect alignment on the two members before gluing the butting cut surfaces to each other.

3. A double-sided ferrule manufacturing method according to claim 2, wherein oil is previously applied to the outer peripheral surface of the guide pin.

4. A double-sided ferrule manufacturing method comprising the steps of: preparing an auxiliary member equipped with a guide pin insertion hole, guide grooves for guiding optical fibers, and optical fiber insertion holes into which the optical fibers can be inserted; inserting a guide pin into the guide pin insertion hole of the auxiliary member and into a guide pin insertion hole of a double-sided ferrule to connect the auxiliary member and the double-sided ferrule with each other; inserting the optical fibers into the optical fiber insertion holes from the guide grooves of the auxiliary member to cause them pass through the insertion holes; and inserting the optical fibers into optical fiber insertion holes of the double-sided ferrule.

5. A double-sided ferrule manufacturing method according to claim 4, wherein the auxiliary member consists of a divisional ferrule obtained by dividing into two a ferrule equipped with two guide pin insertion holes, an optical fiber insertion opening which allows insertion of a fiber ribbon, a plurality of guide grooves for guiding optical fibers, and optical fiber insertion holes into which the optical fibers can be inserted, and wherein the divisional ferrule is the optical fiber insertion hole side divisional ferrule of two divisional ferrules obtained by cutting the portion between the optical fiber insertion opening and the optical fiber insertion holes of a ferrule across the guide pin insertion holes and the guide grooves.

6. A double-sided ferrule manufacturing method according to claim 4 or 5, wherein the auxiliary member and the double-sided ferrule are connected by guide pins so as to be opposed to each other with a gap therebetween.

7. A double-sided ferrule manufacturing method according to one of claims 4 through 6, wherein each of the guide pins is equipped with an insertion restricting portion for restricting the insertion thereof into the auxiliary member and into the double-sided ferrule.

8. An auxiliary member for use in the double-sided ferrule manufacturing method according to any one of claims 4 through 7, the auxiliary member comprising: guide pin insertion holes, guide grooves for individually guiding optical fibers, and optical fiber insertion holes which are formed ahead of the guide grooves and into which the optical fibers can be individually inserted.

9. An auxiliary member for use in the double-sided ferrule manufacturing method according to any one of claims 4 through 7, wherein the auxiliary member consists of an optical fiber insertion hole side divisional ferrule of two divisional ferrules obtained by cutting a ferrule equipped with guide pin insertion holes, an optical fiber insertion opening into which optical fibers can be inserted, guide grooves for guiding the optical fibers, and optical fiber insertion holes into which the optical fibers can be inserted, across the guide pin insertion holes and the guide grooves into an optical fiber insertion opening side portion and an optical fiber insertion holes side portion.

10. A double-sided ferrule end surface polishing method comprising the steps of: preparing two members in each of which one end surface is formed as a joint end surface having two guide pin holes and a plurality of fiber minute holes arranged between the guide pin holes and the other end surface is formed as a gluing end surface, the guide pin holes extending from one end surface to the other end surface; causing the gluing end surface of these two members to butt against each other and gluing them together such that their respective guide pin holes communicate with each other; inserting optical fibers from the fiber minute holes of one member to the fiber minute holes of the other member and fixing the optical fibers to the two members to obtain a double-sided ferrule; and polishing an end surface of the double-side ferrule, with reinforcing members being inserted into the guide pin holes of the two members communicating with each other.

11. A double-sided ferrule end surface polishing method comprising the steps of: preparing two members in each of which one end surface is formed as a joint end surface having two guide pin holes and a plurality of fiber minute holes arranged between the guide pin holes and the other end surface is formed as a gluing end surface, the guide pin holes extending from one end surface to the other end surface; causing the gluing end surface of these two members to butt against each other and gluing them together such that their respective guide pin holes communicate with each other; inserting optical fibers from the fiber minute holes of one member to the fiber minute holes of the other member and fixing the optical fibers to the two members to obtain a double-sided ferrule; and polishing an end surface of the double-side ferrule, with the two members being fixed by a jig astride the end surfaces of the two members glued to each other.

12. An optical connector assembling method in which optical fibers inserted into insertion holes are fixed to a ferrule by an adhesive, wherein after injecting the adhesive into an inlet of optical fiber insertion holes and into an injection window formed in the ferrule so as to communicate with the optical fiber insertion holes, the optical fibers are inserted into the optical fiber insertion holes from the inlet and the adhesive is forced into the optical fiber insertion holes.

13. An optical connector assembling method in which optical fibers inserted into insertion holes are fixed to a ferrule by an adhesive, wherein after inserting the optical fibers into optical fiber insertion holes, the adhesive is injected into an injection window formed in the ferrule so as to communicate with the optical fiber insertion holes, and the adhesive is applied to an inlet side and an outlet side of the optical fiber insertion holes, the fibers being reciprocated (stroked) in the inserting direction to fill the optical fiber holes with the adhesive.

14. An optical connector assembling method in which optical fibers inserted into insertion holes are fixed to a ferrule by an adhesive, wherein the optical fibers are inserted into optical fiber insertion holes, which are filled with the adhesive, and, before the adhesive cures, an optical fiber coating portion of a fibber ribbon on the outer side of the ferrule is cut off to release the optical fibers from the restraint by the coating portion before allowing the adhesive to cure.

15. An optical connector assembling method in which optical fibers inserted into insertion holes are fixed to a ferrule by an adhesive, wherein after allowing the adhesive to undergo thermosetting, a temperature not lower than glass transition temperature is applied to the adhesive to eliminate the distortion of the adhesive generated at the time of thermosetting, then the adhesive is restored from the glass transition temperature to room temperature over a period of time long enough not to generate distortion in the adhesive.

16. An optical connector in which optical fibers inserted into insertion holes are fixed to a ferrule by an adhesive for assembly, wherein after injecting the adhesive into an inlet of optical fiber insertion holes and into an injection window formed in the ferrule so as to communicate with the optical fiber insertion holes, the bare fibers are inserted into the optical fiber insertion holes from the inlet and the adhesive is forced into the optical fiber insertion holes for assembly.

17. A guide pin in the form of a bar adapted to be inserted into guide pin holes of a pair of optical connectors connected through butting, wherein a longitudinal part of the guide pin is formed as a fixing portion that can be forced into the guide pin hole of one optical connector for fixation, the outer diameter of the fixing portion being larger than that of the remaining portion of the guide pin.

18. A guide pin in the form of a bar adapted to be inserted into guide pin holes of a pair of optical connectors connected through butting, wherein a longitudinal part of the guide pin is formed as a fixing portion that can be forced into the guide pin hole of one optical connector for fixation, the fixing portion having a large number of engagement protrusions that can be engaged with the inner peripheral surface of the guide pin hole.

19. A guide pin according to claim 17, wherein, assuming that the maximum outer diameter of the fixing portion is R1 (μm) and that the inner diameter of the guide pin holes of the optical connector is R2 (μm), the following relationship is satisfied: R2≦R1≦R2+2 μm.

20. A guide pin according to claim 18, wherein, assuming that the maximum outer diameter of the fixing portion is R1 (μm) and that the inner diameter of the guide pin holes of the optical connector is R2 (μm), the following relationship is satisfied: R2≦R1≦R2+10 μm.

21. An optical connector connecting method comprising the steps of: inserting the guide pin according to any one of claims 17 through 20 into the guide pin hole of one optical connector from the end surface side on the opposite side of the joint end surface of the optical connector so as to cause a longitudinal part of the guide pin to outwardly protrude from the joint end surface; and inserting the protruding longitudinal part of the guide pin into the guide pin hole of the other optical connector from the joint end surface side of the optical connector to thereby connect the joint end surfaces of the two optical connectors butting against each other.
